(19) United States
(12) Patent Application Publication
(10) Pub. No.: US 2005/0209996 A1
(43) Pub. Date: Sep. 22, 2005

(54) System and method for developing and implementing on-line marketing techniques

(76) Inventor: Kelsey Byron Stewart, Fishers, IN (US)

Correspondence Address: WOODARD, EMHARDT, MORIARTY, MCNETT & HENRY LLP, BANK ONE CENTER/TOWER, 111 MONUMENT CIRCLE, SUITE 3700, INDIANAPOLIS, IN, 46204-5137, US

(21) Appl. No.: 11/080,791

(22) Filed: Mar. 15, 2005

Related U.S. Application Data
(60) Provisional application No. 60/553,735, filed on Mar. 17, 2004.

(51) Int. Cl. G06F 7/00

(52) U.S. Cl. 707/1

(57) ABSTRACT

A computer system and method is disclosed that aids in developing and implementing on-line marketing techniques. Several client workstations and servers are coupled together over a network. A client computer contains a browser user interface to allow an administrator to set up a new business web site account. The new extension web site is immediately accessible to the business at a specified URL. The business can use a client computer browser user interface to create and/or update the site content. A database server stores information related to the business web sites and/or the portal. A web server provides access to the business web sites and portal to client computers. Consumers can access content on one or more business web sites on web server from a client computer either directly or through a portal. The business can advertise the new web site along with their primary web site, if applicable.

### CROSS-REFERENCE TO RELATED APPLICATIONS

This application claims the benefit of U.S. Provisional Application No. 60/553,735 filed Mar. 17, 2004, which application is incorporated herein in its entirety.

### BACKGROUND

The market is full of internet web designers pitching their abilities to create web sites for businesses and individuals. Many are designing and building sites with little or no knowledge about how to create a good web site. Some companies, like Network Solutions, have created templates to help the web designers create aesthetically pleasing sites quickly, but features and functionality of these sites vary greatly. There are several weaknesses with the current internet environment and site creation.

For example, activation of the common URL (xxx.com, xxx.org) is not an instantaneous activation process. Activation of a particular URL can take up to a week at times depending on the source. This delay can hinder business owners from moving quickly into the market and offering their products and services. Also, web site creation and design depends greatly on the “skill set” and the “abilities” of the designers. Because of this, final product delivery (web sites) can reflect a vast spectrum of results from very poor to excellent developmental results. Many companies have each spent thousands of dollars on hiring someone to build their web sites and have never been able to use them.

Initial web site creation can be very costly. Most designers in the marketplace try to charge anywhere from $2,000 to $10,000 for a custom web site. This may be one reason why most business owners, particularly small business owners, do not have a site. Another reason for the lack of web technology or internet sites used by small businesses is the lack of computer education and control they have to work with the internet sites. Most see no value in spending the money because it is only for “informational” data and they cannot easily market items, promotions or event activities to new customers in their immediate service area.

Web site maintenance and support can be a trap. It is nice to have a web site but after the initial build, business owners still need to update their site or change something about it. There are a lot of business owners/managers who are trapped in paying fees to designers and programmers to update even the most simple photos, products, items etc to their sites. Business owners pay in the range of $50.00 to $500.00+ per transaction for simple updates to the designing agencies or designers themselves. A business owner might be led into a joint venture to build their new site in an inexpensive way but on the “back side” of the agreement, the update and change requests are the “cash cows” to the builder or designer. This happens quite often to small business owners and many feel they are trapped.

The World Wide Web is not necessarily a friendly or easy-to-use environment for consumers and/or shoppers. There are several reasons why the common .com's/.org's etc. are not frequented more regularly by the masses. One reason is because it is difficult to browse and/or shop for items and information on the web because of the individuality and format of each site. There is really no standardization in site format and/or functionality between sites. For example: You can go shopping for a dress but if you go into Macys.com, Dillards.com, Marshalls.com, etc., the shopper has to learn how to manipulate each of the sites independently of each other because their formats are not standardized. This makes it harder to shop for items and services.

Another reason is because the current search engines (Google, AltaVista, Yahoo, etc) are not good at isolating products and services for consumers in small or large geographical areas. For research purposes, the giant search engines work very well with indexing the large numbers of documents and sites that pertain to high level research. But when it comes down to finding a particular product or service available at a merchant store in a small geographical area (say: Northeast Indianapolis, Downtown Baltimore or Hillsboro, Tex.), the engines fail because there is no standardization to indexing products, services, menu items, etc. with addresses or site location indexing. As it stands now, the search engines are unable to provide consumers with the ability to see the “full view” of businesses, product categories, local event schedules and services in specific geographical/community areas.

Let's take the retailer OLD NAVY™ for example: Each OLD NAVY™ store location has similar products and services but they differ from each other. A customer living in Indianapolis may not care about shopping at oldnavy.com because it is not the most simple or fulfilling way to shop for that individual. The customer does not care about the OLD NAVY™ store in Florida or even the OLD NAVY™ store on the other side of town. The customer only cares about shopping at the OLD NAVY™ store in the community near to where they live. Currently that customer does not have any way to look into a particular store or shopping center and see what kind of products, sales, coupons, offering, etc. that single and/or multiple site(s) have to offer. Further advancements are needed in these areas.

Another marketing-related problem facing businesses today involves the use of coupons. Many businesses pay to have coupons for their products or services placed in a coupon booklet or other advertisement to help stimulate business. The problem with this approach is that a potential customer may be interested in one or more products or services offered by the company, but not the particular product or service advertised on the coupon. Print material is what we call a “dead format” in which the offers cannot change once the coupons are printed. A “live format” is where management/owners of particular establishment can instantly change the offers day or night allowing them to be in control. Most coupon-based sites do not reflect a “live format” because the company that controls the site does not allow the client to manipulate the offers day or night and maintain control. The coupons for these sites are not usually aesthetically pleasing to the eye and fall short of many consumers wants. Further advancements are also needed in this area.

### SUMMARY

One form of the present invention is a unique system for developing on-line web sites.

Yet another form includes unique systems and methods to develop and implement on-line marketing techniques.

Another form includes operating a computer system that has several client workstations and servers coupled together over a network. At least one client computer contains a browser user interface for setting up a new business web site account. At least one client computer contains a browser user interface for creating and/or updating the new business web site content. At least one client computer contains a browser user interface for accessing content on one or more business web sites either directly or through a portal application. At least one server is a web server that provides access to the business web sites and portal to client computers. At least one server is a database server that stores at least part of the information related to the business web sites and/or the portal.

Another form includes a computer system and method for developing and implementing on-line marketing techniques. An administrator first sets up a new account for a business, or the account is set up programmatically. Each business site is assigned a unique URL which incorporates a unique sub-domain and a common extension of an existing domain (ex: www.sub-domain.domain.com). The new extension web site is accessible immediately or nearly immediately to the business at a specified URL, without having to wait for a domain name registration and activation process. The business or third party agent sets up the web site with desired content. The business can advertise the new extension web site along with their primary web site, if a separate primary web site is also available. Otherwise, the extension web site can also serve as the primary web site for the business. Customers can view information about the business by visiting the business extension web site directly or getting to the business extension web site through a portal that drills-down to the particular business site through categories. If the business has a main web site, the extension web site allows the business to show a “snap shot” of the best of their business and promotions in a standardized format for all businesses and locations. If the client wants more information and/or details in regards to the business, they can access the main web site through the extension site.

Yet other forms, embodiments, objects, advantages, benefits, features, and aspects of the present invention will become apparent from the detailed description and drawings contained herein.

### BRIEF DESCRIPTION OF THE DRAWINGS

FIG. 1 is a diagrammatic view of a computer system of one embodiment of the present invention.

FIG. 2 is a high-level process flow diagram for the system of FIG. 1.

FIG. 3 is a process flow diagram for the system of FIG. 1 demonstrating the stages involved in creating and maintaining an extension web site.

FIG. 4 is a process flow diagram for the system of FIG. 1 demonstrating the stages involved in using the portal to view business extension web sites by categories.

FIG. 5 is a process flow diagram for the system of FIG. 1 demonstrating the stages involved in using the extension web site to assist in advertising.

FIG. 6 is a process flow diagram for the system of FIG. 1 demonstrating the stages involved in using the extension web site to assist in coupon redemption.

FIG. 7 is a process flow diagram for the system of FIG. 1 demonstrating the stages involved in using the extension web site to assist in coupon redemption from a remote location.

FIG. 8 is a simulated screen of an administrator tool in a browser user interface for one or more client workstations of FIG. 1 that illustrates selecting a setting or web site to modify.

FIG. 9 is a simulated screen of an administrator tool in a browser user interface for one or more client workstations of FIG. 1 that illustrates modifying the settings for a selected extension business web site.

FIG. 10 is a simulated login screen in a browser user interface for one or more client workstations of FIG. 1 that illustrates allowing a business to log in to a customization tool for their extension web site.

FIG. 11 is a simulated screen of a customization tool in a browser user interface for one or more client workstations of FIG. 1 that illustrates allowing a business various options to customize their extension web site.

FIG. 12 is a simulated screen of a customization tool in a browser user interface for one or more client workstations of FIG. 1 that illustrates allowing a business to upload different logos for their extension web site.

FIG. 13 is a simulated screen of a customization tool in a browser user interface for one or more client workstations of FIG. 1 that illustrates allowing a business to upload a background logo or custom banner for their extension web site.

FIG. 14 is a simulated screen of a customization tool in a browser user interface for one or more client workstations of FIG. 1 that illustrates modifying a description for the particular extension web site.

FIG. 15 is a simulated screen of a customization tool in a browser user interface for one or more client workstations of FIG. 1 that illustrates allowing a business to modify the headers for their extension web site.

FIG. 16 is a simulated screen of a customization tool in a browser user interface for one or more client workstations of FIG. 1 that illustrates adding a promotion or other item for the particular extension web site.

FIG. 17 is a simulated screen of a customization tool in a browser user interface for one or more client workstations of FIG. 1 that illustrates updating an existing promotion or other item for the particular extension web site.

FIG. 18 is a simulated screen of a customization tool in a browser user interface for one or more client workstations of FIG. 1 that illustrates uploading a spreadsheet containing content to be displayed on the particular extension web site.

FIG. 19 is a simulated screen of a customization tool in a browser user interface for one or more client workstations of FIG. 1 that illustrates searching for client contacts stored in the particular extension web site database.

FIG. 20 is a simulated screen of a customization tool in a browser user interface for one or more client workstations of FIG. 1 that illustrates search results for client contacts meeting the specified criteria in the particular extension web site.

FIG. 21 is a simulated screen of a customization tool in a browser user interface for one or more client workstations of FIG. 1 that illustrates inputting a new online item/offer for the particular extension web site.

FIG. 22 is a simulated screen of a customization tool in a browser user interface for one or more client workstations of FIG. 1 that illustrates adding or modifying an address for the company using the particular extension web site.

FIG. 23 is a simulated screen of a customization tool in a browser user interface for one or more client workstations of FIG. 1 that illustrates modifying/uploading store photos to be included on the particular extension web site.

FIG. 24 is a simulated screen of a customization tool in a browser user interface for one or more client workstations of FIG. 1 that illustrates modifying the color scheme for the particular extension web site.

FIG. 25 is a simulated screen of a browser user interface for one or more client workstations of FIG. 1 that illustrates viewing a primary page of an extension web site.

FIG. 26 is a simulated screen of a browser user interface for one or more client workstations of FIG. 1 that illustrates viewing a secondary window of an extension web site.

FIG. 27 is a simulated screen of a browser user interface for one or more client workstations of FIG. 1 that illustrates viewing a selected coupon/promotion for a particular extension web site.

FIGS. 28-30 are simulated screens of a browser user interface for one or more client workstations of FIG. 1 that illustrate using a portal to access extension web sites by navigating through various categories.

### DETAILED DESCRIPTION OF SELECTED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

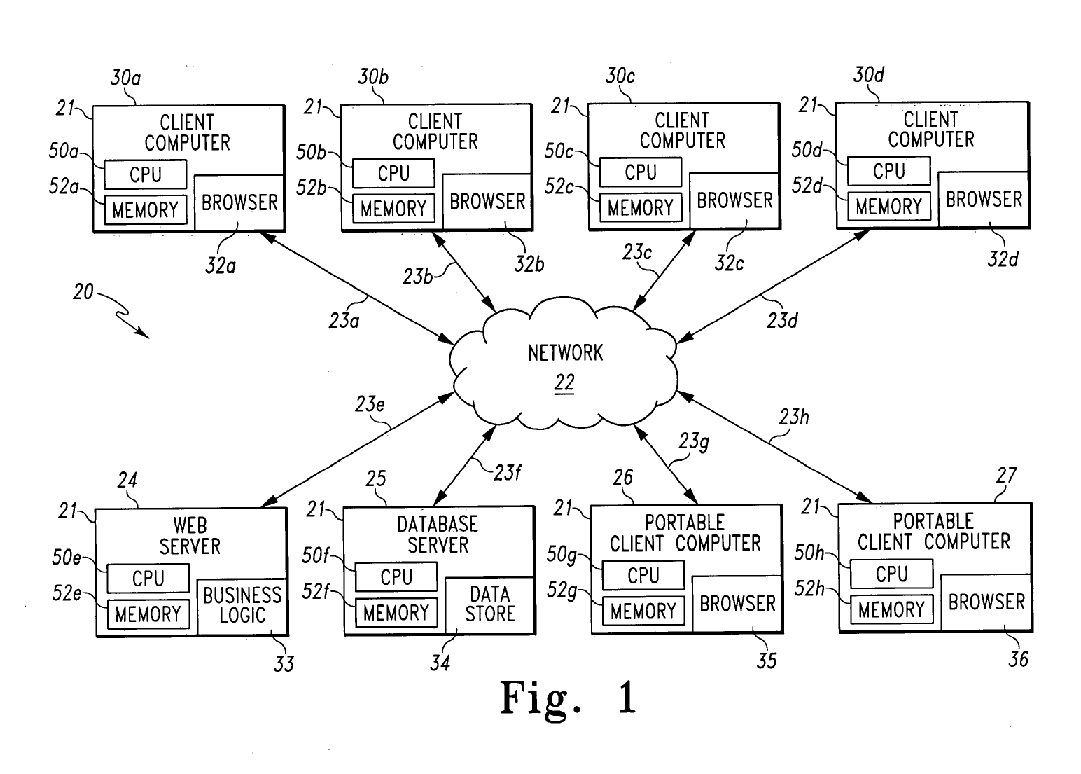

One embodiment of the present invention includes a unique system for implementing on-line marketing techniques. FIG. 1 is a diagrammatic view of computer system 20 of one embodiment of the present invention. Computer system 20 includes computer network 22. Computer network 22 couples together a number of computers 21 over network pathways 23a-h. More specifically, system 20 includes several servers, namely Web Server 24 and Database Server 25. System 20 also includes client workstations 30a, 30b, 30c, and 30d (collectively 30), and portable client computers 26 and 27, such as a personal digital assistant (PDA). While computers 21 are each illustrated as being a server or client, it should be understood that any of computers 21 may be arranged to include both a client and server. Furthermore, it should be understood that while eight computers 21 are illustrated, more or fewer may be utilized in alternative embodiments.

Computers 21 include one or more processors or CPUs (50a, 50b, 50c, 50d, 50e, 50f, 50g, and 50h, respectively) and one or more types of memory (52a, 52b, 52c, 52d, 52e, 52f, 52g, and 52h, respectively). Each memory 52a, 52b, 52c, 52d, 52e, 52f, 52g, and 52h includes a removable memory device. Each processor may be comprised of one or more components configured as a single unit. Alternatively, when of a multi-component form, a processor may have one or more components located remotely relative to the others. One or more components of each processor may be of the electronic variety defining digital circuitry, analog circuitry, or both. In one embodiment, each processor is of a conventional, integrated circuit microprocessor arrangement, such as one or more PENTIUM III or PENTIUM 4 processors supplied by INTEL Corporation of 2200 Mission College Boulevard, Santa Clara, Calif. 95052, USA.

Each memory (removable or generic) is one form of computer-readable device. Each memory may include one or more types of solid-state electronic memory, magnetic memory, or optical memory, just to name a few. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM); an optical disc memory (such as a DVD or CD ROM); a magnetically encoded hard disc, floppy disc, tape, or cartridge media; or a combination of any of these memory types. Also, each memory may be volatile, nonvolatile, or a hybrid combination of volatile and nonvolatile varieties.

Although not shown to preserve clarity, in one embodiment each computer 21 is coupled to a display. Computers may be of the same type, or a heterogeneous combination of different computing devices. Likewise, displays may be of the same type, or a heterogeneous combination of different visual devices. Although again not shown to preserve clarity, each computer 21 may also include one or more operator input devices such as a keyboard, mouse, track ball, light pen, and/or microtelecommunicator, to name just a few representative examples. Also, besides a display, one or more other output devices may be included such as loudspeaker(s) and/or a printer. Various display and input device arrangements are possible.

Computer network 22 can be in the form of a Local Area Network (LAN), Municipal Area Network (MAN), Wide Area Network (WAN), such as the Internet, a combination of these, or such other network arrangement as would occur to those skilled in the art. The operating logic of system 20 can be embodied in signals transmitted over network 22, in programming instructions, dedicated hardware, or a combination of these. It should be understood that more or fewer computers 21 can be coupled together by computer network 22.

In one embodiment, system 20 operates at one or more physical locations where Web Server 24 is configured as a web server that hosts application business logic 33, Database Server 25 is configured as a database server for storing relational and other data 35, client workstations 30a-30d are configured for providing a browser-based user interface 32a-32d, respectively, and portable client computers 26 and 27 are configured for providing a browser-based user interface 35 and 36, respectively. Typical applications of system 20 would include more or fewer client workstations of this type at one or more physical locations, but four have been illustrated in FIG. 1 to preserve clarity. Furthermore, although two servers are shown, it will be appreciated by those of ordinary skill in the art that the one or more features provided by Web Server 24 and Database Server 25 could be provided on the same computer or varying other arrangements of computers at one or more physical locations and still be within the spirit of the invention. Farms of dedicated servers could also be provided to support the specific features if desired.

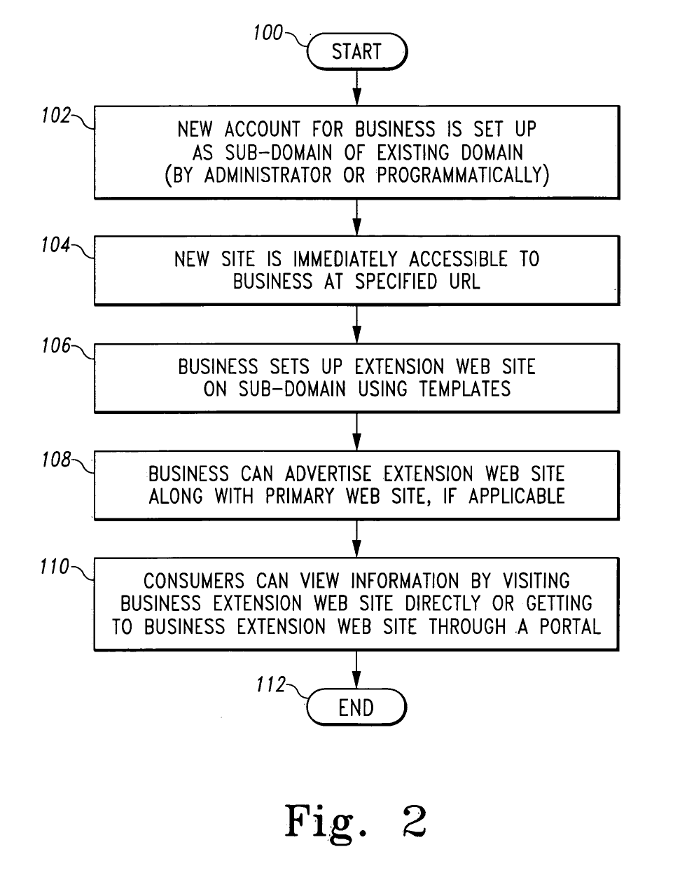

Referring also to FIG. 2, one embodiment for implementing system 20 is illustrated in flow chart form as procedure 100, which demonstrates a high-level process for the system of FIG. 1 and will be discussed in more detail below. In one form, procedure 100 is at least partially implemented in the operating logic of system 20. Procedure 100 begins with a new web site business account being set up by an administrator, or set up programmatically, such as when a user enrolls online and pays a fee (stage 102). Each business site is assigned a unique URL which incorporates a unique sub-domain and a common extension of an existing domain (ex: www.sub-domain.domain.com). The new site is immediately accessible to the business at the specified URL (stage 104). In other words, going through a domain name service in order to obtain the new domain is not necessary, because of the common extension that already exists. The business or a third party assisting the business sets up the extension web site on the sub-domain by accessing a specified customization URL and then using a customization tool that has one or more templates (stage 106). The customization URL may be the same or a different URL than the specified URL that end customers will use to access the extension web site. The business can advertise the extension web site along with a primary web site, if applicable (stage 108). If the business does not have a separate main web site, then the extension web site is their main web site. Consumers can then view information by visiting the business extension web site directly or visiting the business extension web site through a portal (stage 110). In one embodiment, as part of the membership for having an extension web site account, the extension web site is automatically included in the portal and/or one or more sub-portals so that the company's products and services can be made available to a broader spectrum of potential consumers. The process then ends at stage 112. Each of these features will now be described in greater detail herein.

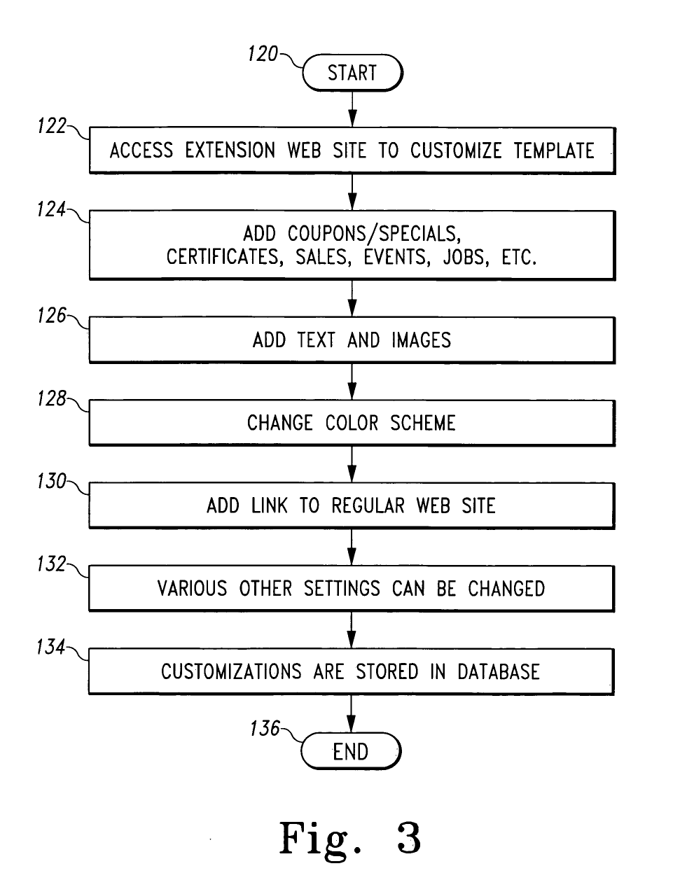

Referring now to FIG. 3, procedure 120 demonstrates the stages involved in creating and maintaining an extension web site. Procedure 120 begins with the business or third party agent (the web site “builder”) accessing the extension web site to customize the site using one or more standard templates (stage 122). A unique ID and Access Code will be given to the business owner so they can access the “edit menu” that will allow them to change anything in their new extension web site day and night. Modifications can be made to the site in various orders. For example, coupons/specials, certificates, sales, events, jobs, products, programs, classes, informational materials, etc. can be entered and/or uploaded (stage 124), additional text and images (stage 126) can be inserted, and the site color scheme can be modified (stage 128). A hyperlink can be added to direct the consumer to the regular web site (if applicable) (stage 130) and the address of the business can be changed. Various other settings can also be modified (stage 132). As one non-limiting example, the user can specify whether to allow customers to sell their own items on the extension web site. Suppose, for example, that a piano company has an extension web site and they also want to allow their customers to list used pianos for sale as a service for their other customers. The extension web site customization tool can allow them to enable an option that allows their customers to add such items for sale or promotion.

As a second non-limiting example, the user can specify whether the company wants to participate in electronic commerce and make items for sale electronically. In one embodiment, the extension web site provider can manage the processing of electronic payments across the various extension web sites, so customers can purchase items from multiple extension web sites and have a single checkout. In such a scenario, the extension web site provider or authorized agent provides separate orders to each extension web site company for fulfillment, and provides payment separately to each extension web site company. The customization tool allows a user to specify that the company of the extension web site wishes to participate in the e-commerce program and agrees to be bound to its terms. In another embodiment, new items for sale can also be placed by telephone using interactive voice response (IVR) technology for listing on the extension web site of the particular company. Alternatively or additionally, orders from customers can be placed by telephone.

As a third non-limiting example of the additional types of options that can be customized using the customization tool, a photo bank can be offered to allow the company to use one or more of a number of freeware images or images available for purchase on the particular extension web site.

As a fourth non-limiting example, another option that can be enabled is to allow the user to enable a blog section which allows the company and/or consumers to add blog entries (web log entries) onto the extension web site, so that employees of the company and/or consumers can post relevant topics for discussion.

As a fifth non-limiting example, the category in which an item is listed in the site: Product, Menu Item, Service, Sale, Event, Educational Material, Coupon, etc. can also be modified. The customizations are stored in a common merchant full text and image database 25 (stage 134). The business can use the extension site to advertise events, sales, educational materials, products, items and/or services, as several non-limiting examples. The process then ends at stage 136.

If a third party builder assisted in setting up the initial site, the business owner will be provided with a brief training session on how to use the program. After that, the business owner should be able to work independently on their site and keep it up-to-date. Even those with little or no training on computers can use system 20 to build “full web sites” quickly, such as 10 to 15 minutes as one example. The site(s) can be created for anyone: businesses, schools, teachers, medical facilities, churches . . . any establishment or individual. Each site incorporates easy uploading and creation of: Products, Services, Menu Items, Events, Coupons, Sales, Educational Materials, Maps, Photos, etc. The program is designed to allow the business owner to edit his/her web site content and marketing promotions without the help of any outside source or contract help. Text and images are loaded quickly and easily into the site. All images are filtered and sized appropriately by the extension web site builder software automatically.

Various file formats can be uploaded to the site, such as: Adobe Acrobat Document (*.pdf), Adobe Illustrator Document (*.ai), Adobe Photoshop Image (*.psd), Bitmap Image (*.bmp), GIF Image (*.gif), JPEG Image (*.jpg,*.jpeg), PCX Image Document (*.pcx), PICT Image (*.pic), PNG Image (*.png), PostScript (*.ps), Scalable Vector Graphics (*.svg,*.svgz), TARGA Image (*.tga,*.vda), TIF Image Document (*.tif,*.tiff), Windows Enhanced Metafile (*.emf), and Windows Metafile (*.wmf), to name some examples.

In the simulated screens and examples illustrated herein, EXT1™ is sometimes used to refer to the extension web sites, and is the domain used for the example extension web sites (e.g. www.sub-domain.ext1.com). Other domains could also be used as the domain for hosting the extension web sites. While extension web sites will be extensions to a lot of main web sites, for most businesses and/or merchants, the extension web site will be their only web site.

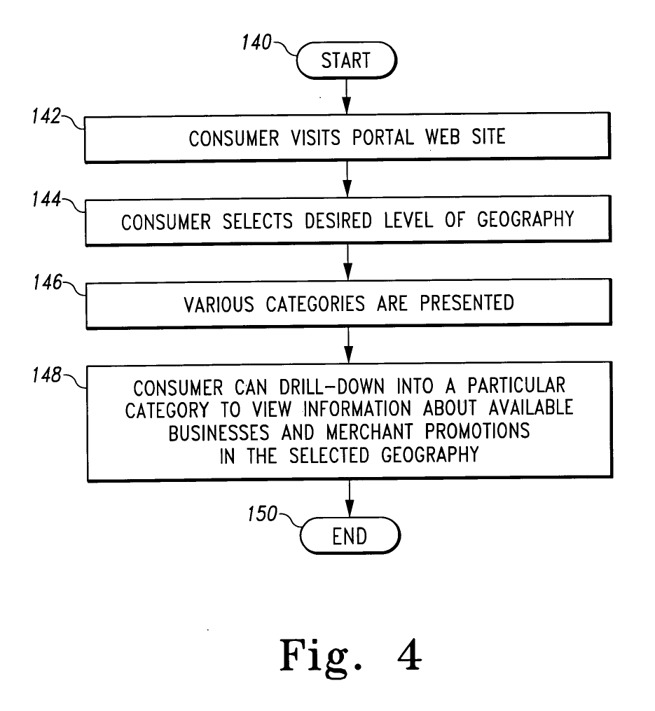

Turning now to FIG. 4, procedure 140 demonstrates the stages involved in using the portal to view business extension web sites by categories. Procedure 140 begins with the consumer visiting the portal web site (stage 142). The consumer selects the desired level of geography (stage 144). Various categories are then presented (stage 146). The consumer can drill-down into a particular category to view information about available businesses in the selected geography that have extension web sites (stage 148). For example, the consumer can drill-down to a particular business or group of businesses based on categories such as events, sales, educational materials, products, items and/or services, as a few non-limiting examples. Various other types of drill-down techniques could also be used. The procedure then ends at stage 150.

In one embodiment, a master portal site includes each extension web site on a particular extension domain. Companies using the extension web site service can automatically be included in the portal as part of their membership, or they can pay additional fees to be included in alternate embodiments. Alternatively or additionally, a portal site can include extension web sites across multiple extension domains. Alternatively or additionally, one or more sub-portals can be created as desired based on a particular theme the respective extension web sites have in common, such as a health portal showcasing all of the medical related businesses and health food stores in an area.

The portal allows the consumer to shop with ease in a small community or local market, whether it be a community where the person is physically present or a community where the person plans to travel in the future. There are many internet sites out there that consolidate internet “links” into a display of local stores. However, these sites do not allow hoppers or consumers to access and search a large portion, if not all, of the local merchants, in all vertical markets by products, menu items, sales, promotions, services, etc. in small communities in which the consumer lives or visits while traveling.

Merchant products, services, geographical information, offerings, etc. are uploaded into the community portal pages and extension web site upon request. All information from this common database 25 can be downloaded into devices to be used to view local and national merchants while shopping in a local market or traveling abroad. Because community portal pages are Internet based, they can effectuate electronic commerce and interactive advertising through multiple devices and formats: web, laptops, facsimile machines, multi-functional devices, phones, notebook computers, palmtop computers (PALM PILOT), Kiosk, personal computers (PC), PC terminals (NET PC), network computers (NC) and any other device that can display the extension web sites and their promotions.

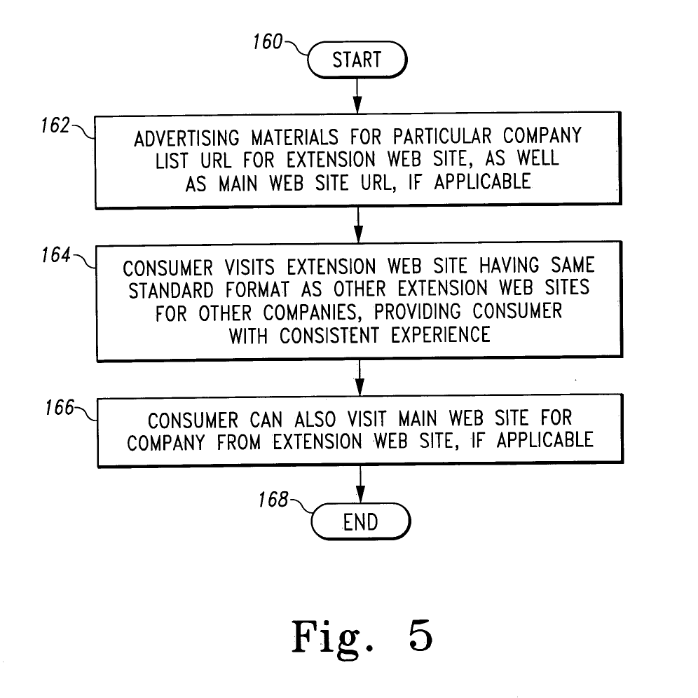

Turning now to FIG. 5, procedure 160 demonstrates the stages involved in using the extension web site to assist in advertising. Procedure 160 begins by providing advertising materials for the particular business that list the URL for extension web site, as well as main web site URL, if applicable (stage 162). In one embodiment, all extension web site accounts are required to place the extension web site “shield” on all their marketing materials if the extension web site URL is advertised. As one non-limiting example, the extension web site shield, can include a logo of the service provider that owns and/or manages the collective set of extension web sites, and the URL of the extension web site address for the individual company can be displayed next to the logo of the service provider.

The consumer then visits the extension web site having same standard format as the other extension web sites for other companies, and is thereby provided with a consistent experience (stage 164). The consumer can also visit the main web site for the business from the hyperlink in the extension web site, if applicable (stage 166). By advertising the main web site and the extension web site side by side, the consumer is made aware that the extension web site will be in a standard format that allows the business can easily update promotions, coupons, products, etc. and therefore they should visit the site regularly. The procedure then ends at stage 168.

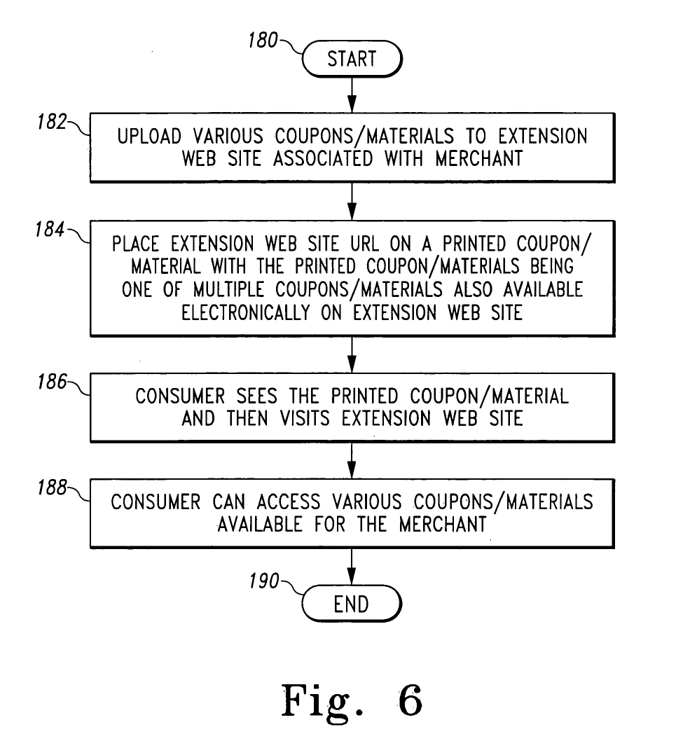

Turning now to FIG. 6, procedure 180 demonstrates the stages involved using the extension web site to assist in coupon/promotion redemption. Procedure 180 begins with the business or third party site builder uploading various coupons or other promotional materials or offers to the extension web site associated with the business (stage 182). The extension web site URL is placed on a printed promotional material, such as a coupon, with the printed material being one of multiple promotional materials also available electronically on extension web site (stage 184). The consumer sees a copy of the printed material, and then visits the extension web site (stage 186). On the extension web site, the consumer can access various promotional materials available for the business, not just the printed material they obtained (stage 188). This allows the consumer to view and print other promotional materials or offers that may be of interest. This process described in FIG. 6 can also be used with other informational materials, such as course listings, job listings, etc. In such examples, a printed material may include only one or a few of many items of interest to the consumer, and upon visiting the extension web site, the additional items of interest can also be accessed. The procedure then ends at stage 190.

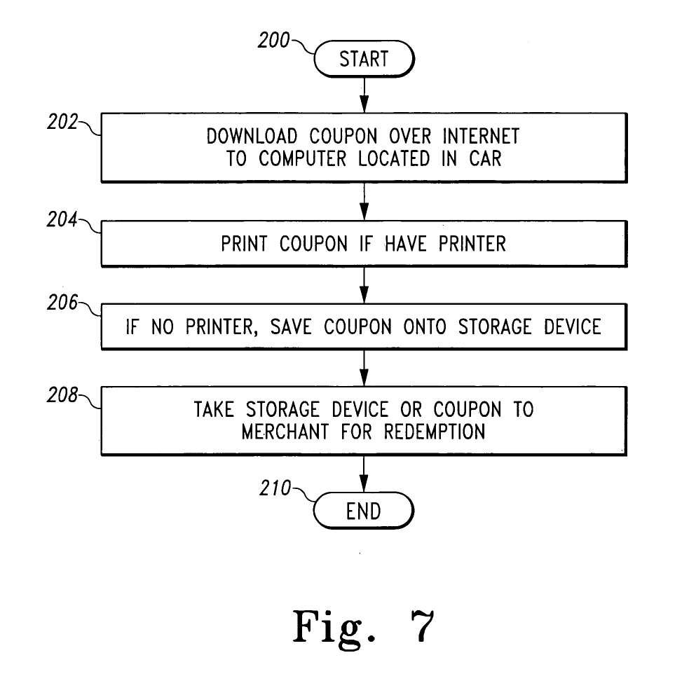

Turning now to FIG. 7, procedure 200 demonstrates the stages involved using the extension web site to assist in coupon redemption from a remote location. While traveling out of town, the consumer downloads a coupon over network 22, such as the Internet, to portable client computer 26 or 27 that they have with them (stage 202). Client computer 26 or 27 can be a PDA or a command system integrated into the car, as a few examples. If a portable printer is available, consumer can print the coupon (stage 204). If no printer is available, the consumer saves the coupon onto a storage device (stage 206). The consumer then takes the storage device or coupon to the business for redemption (stage 208). The procedure then ends at stage 210.

For example, through GPS positioning and links into the community portal, consumers can quickly gain access to local market information and/or communities when traveling. Community pages will search for restaurants, hotels, schools, medical facilities . . . all site locations and industries and access extension web site promotions, sales, coupons, etc. . . . for any town or community.

In one embodiment, selected promotions from extension web sites are “burned” onto a “stored value” card or a type of “bank card” that is inserted in the back of the portable client computer. Optionally, the device has the ability to print “hard copy” coupons upon request if so desired. To redeem the coupon/offer on the card, the cards are swiped through the merchant processing devices at merchant location and the value of the coupon is rewarded/deducted automatically from the consumer's final merchant receipt. Example: you find a $5.00 OFF coupon at Denny's Restaurant's extension web site on your automobile screen, PDA, etc. . . . located while traveling in Florida. You download the $5.00 Off Coupon and the extension web site merchant account information to your handheld device. You then “insert” the storage card into the handheld device and press “store” or “load”. This automatically loads that particular coupon/offer onto the card to be deducted upon swiping the card through the merchant processing device at each location. (Credit Card Terminal). Multiple coupons, for example grocery coupons, can be stored and processed at checkout also for particular retailers.

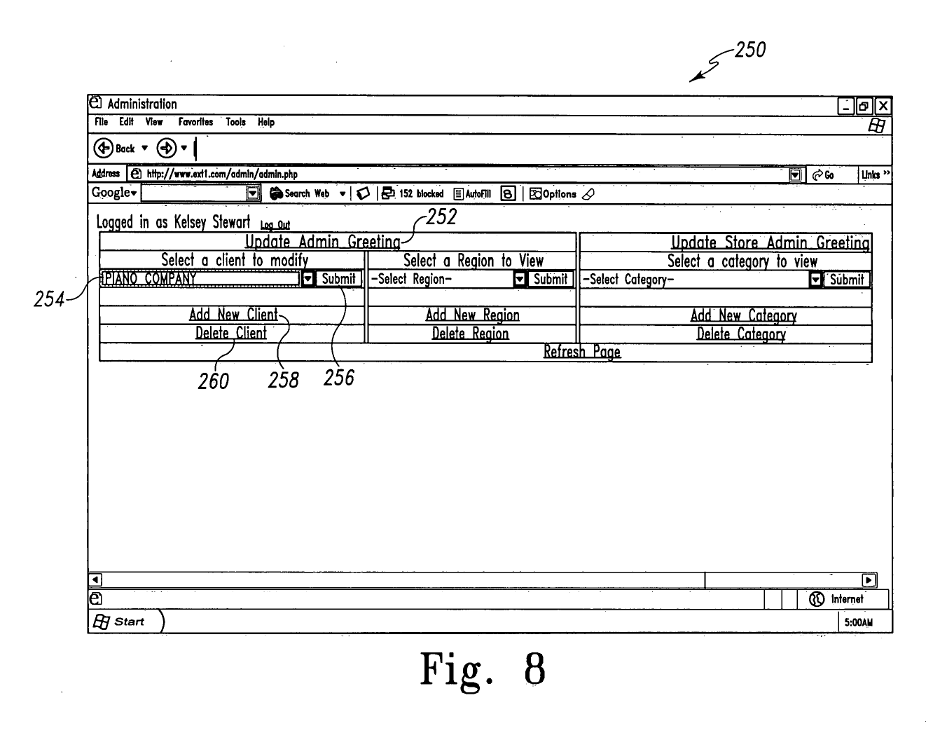

Various simulated screen shot will now be illustrated to provide examples of the procedures described in FIGS. 2-7. For example, FIG. 8 is a simulated screen 250 of an administrator tool in a browser user interface for one or more client workstations that illustrates selecting a setting or web site to modify. The administrative greeting can be modified by selecting update option 252. The user can select a client extension web site to modify 254 and the select the submit option 256 to modify the selected site. A new client extension web site can also be added by selecting Add New Client option 258, or an existing client extension web site can be deleted by selecting Delete Client 260.

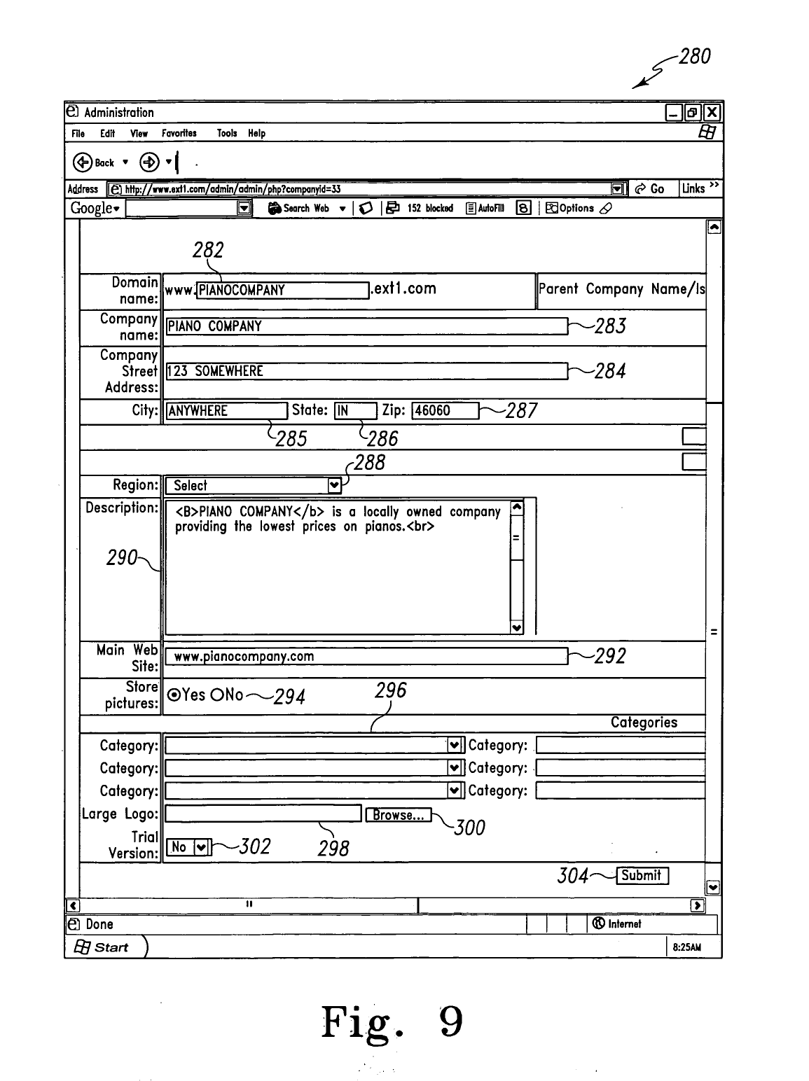

FIG. 9 is a simulated screen 280 of an administrator tool in a browser user interface that illustrates modifying the settings for a selected extension business web site. The screen shows various settings for the web site, such as the Domain Name 282, Company Name 283, Company Street Address 284, City 285, State 286, Zip 287, Region 288, Description 290 (in a format such as HTML code), field for Main web site 292, indicator for whether there will be store pictures 294, various categories selections 296, a logo field 298, browse for logo option 300, and a trial version indicator 302. The user can select the Submit option 304 to submit the information to the database. This and the other screens could be configured in various ways and still be within the spirit of the invention.

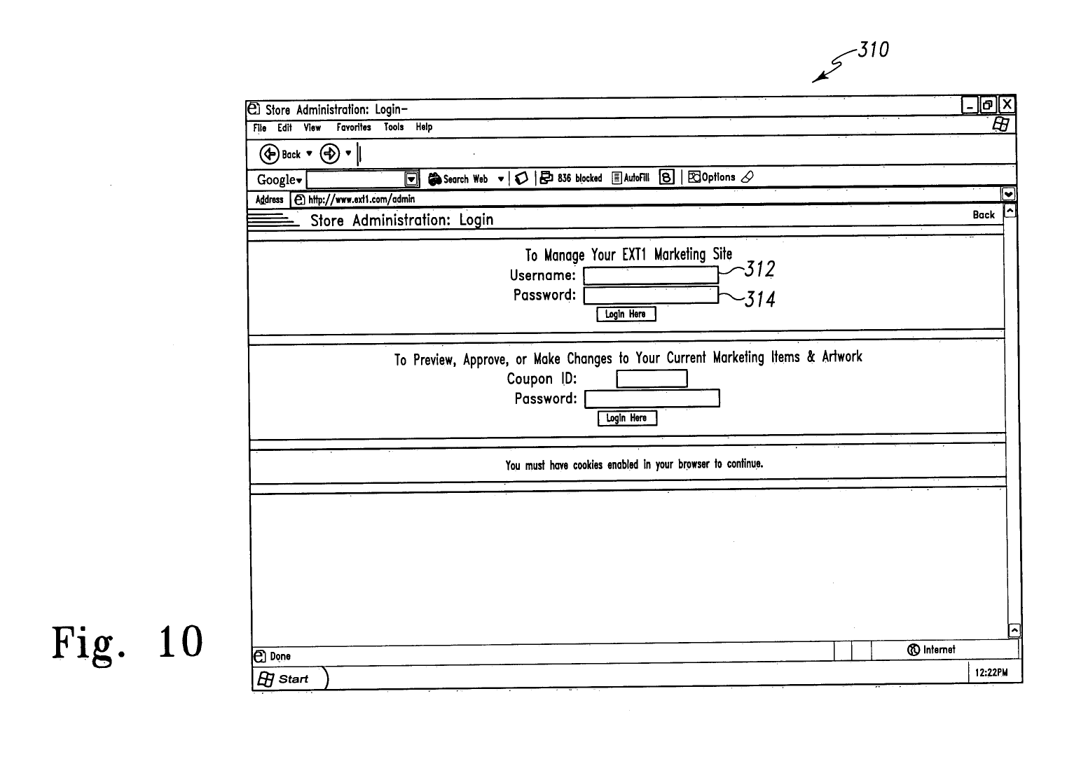

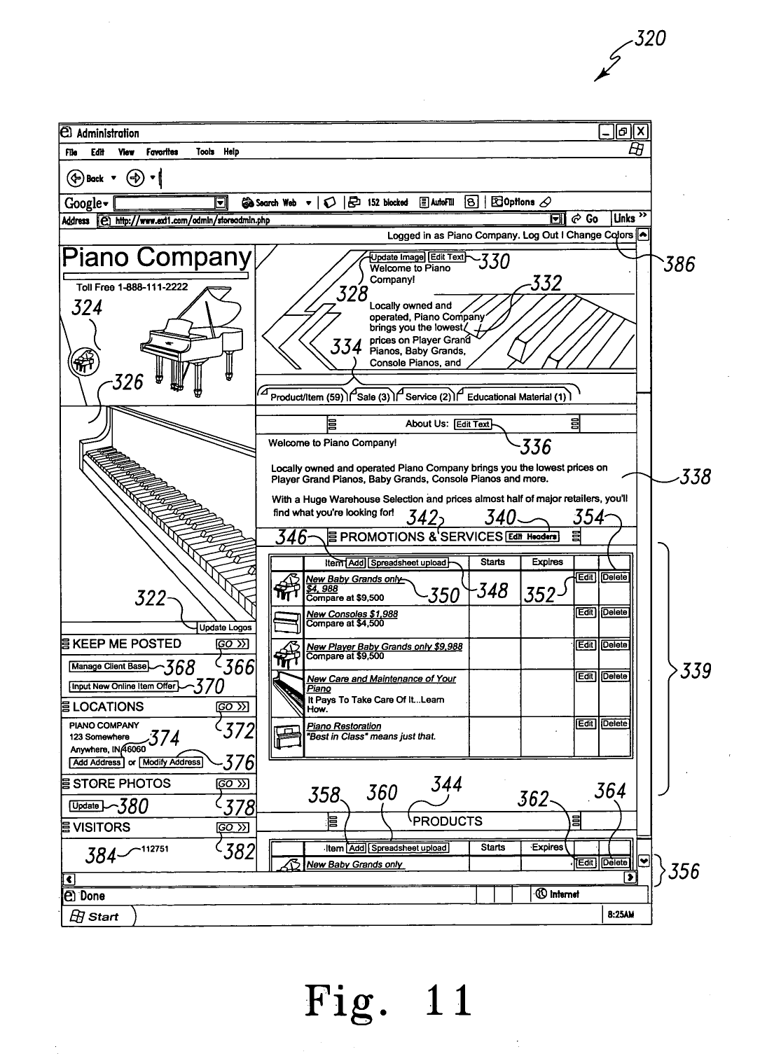

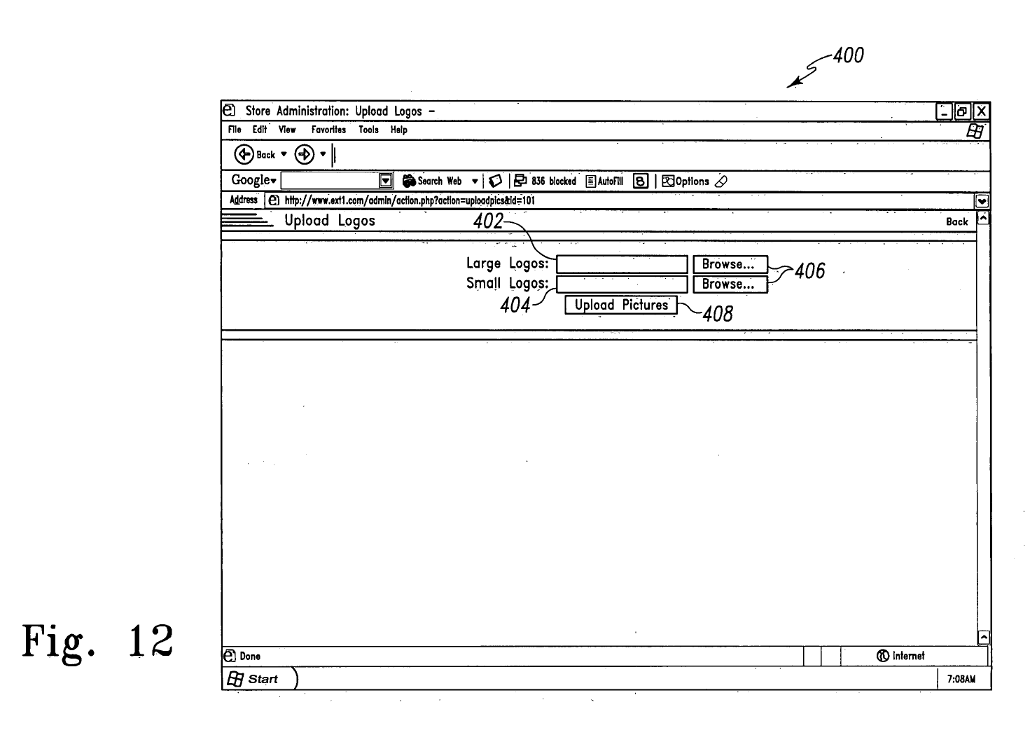

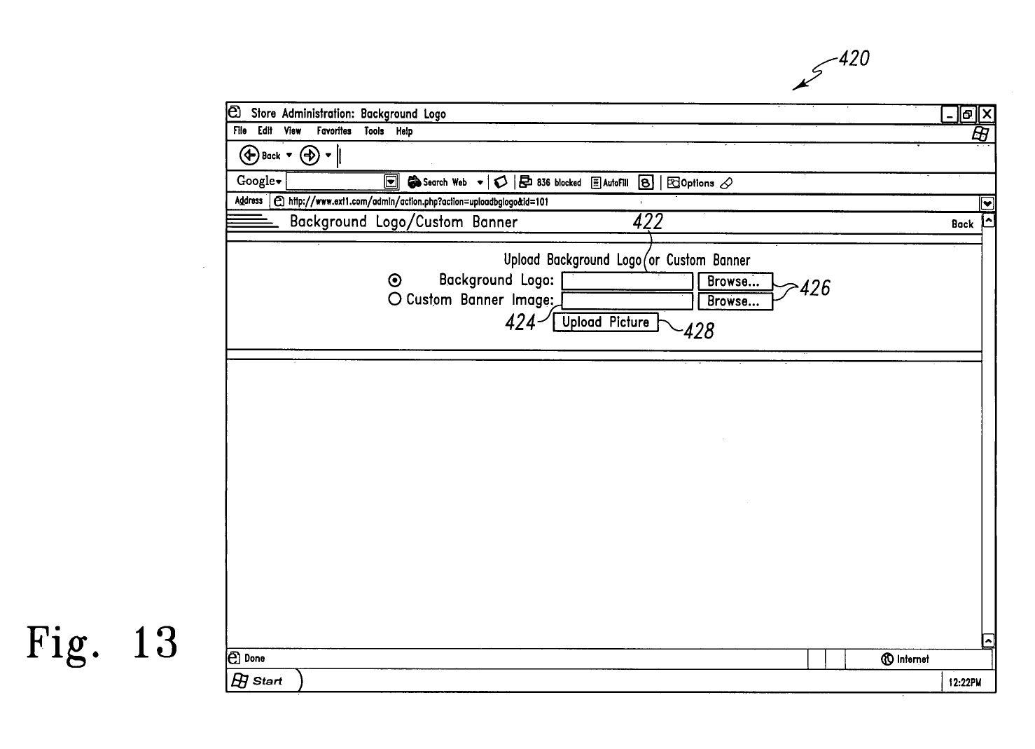

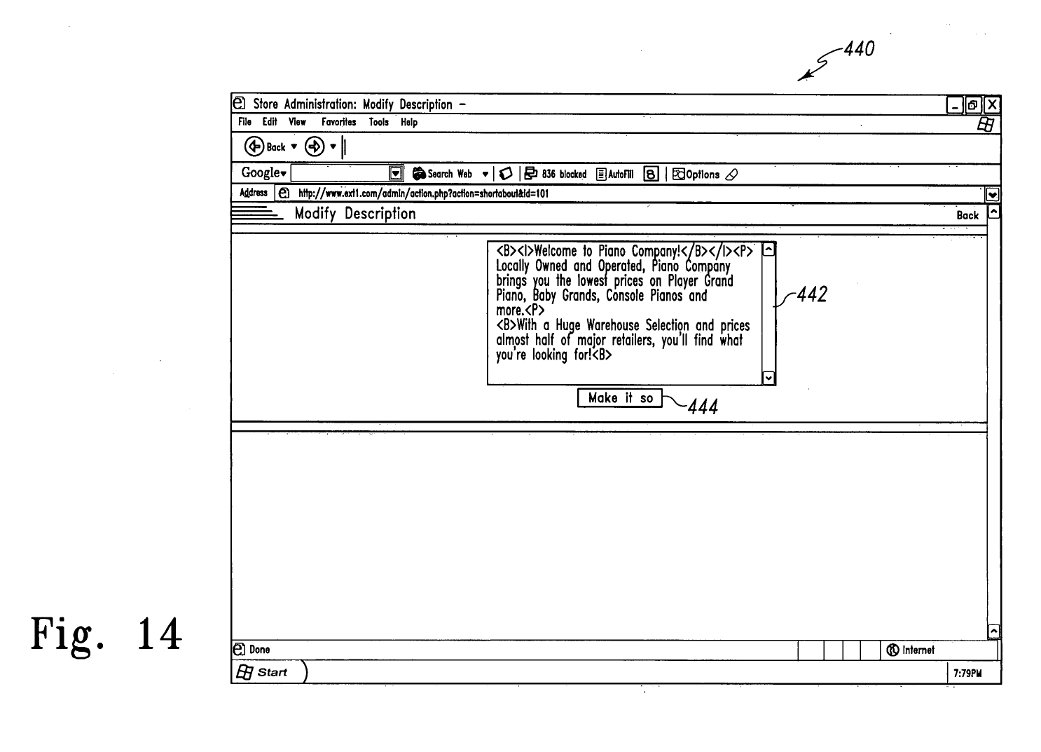

Turning now to FIG. 10, a simulated login screen 310 illustrates allowing a user to log in to the particular extension web site after specifying a valid username 312 and password 314 and selecting a login option. Turning now to FIG. 11, a simulated screen 320 of a customization tool in a browser user interface for one or more client workstations illustrates providing a business or third party builder various options to customize the particular business extension web site. Various hyperlinks or options can be selected to edit the various aspects of the template. For example, upon selecting update logos option 322, logos 324 and 326 can be modified from customization screen 400 (FIG. 12) by modifying the large logo field 402 and small logo field 404, and using the browse option 406 to locate the files if necessary. The logos can then be uploaded upon selection of the upload pictures option 408. Returning to FIG. 11, the upload images option 330 allows the user to upload a background logo or custom banner from the customization screen 420 (FIG. 13) by modifying background logo field 422 and/or custom banner image field 424, selecting the browse option 426 if necessary to find the file, and then uploading the picture(s) upon selecting the upload picture option 428. Returning to FIG. 11, upon selecting edit text option 330 or 336, the text for the particular content pane (332 or 338, respectively) can be edited using the customization screen 440 (FIG. 14) and modifying the text description field 442. Upon selecting the make it so option 444, the text values are changed in the respective content pane.

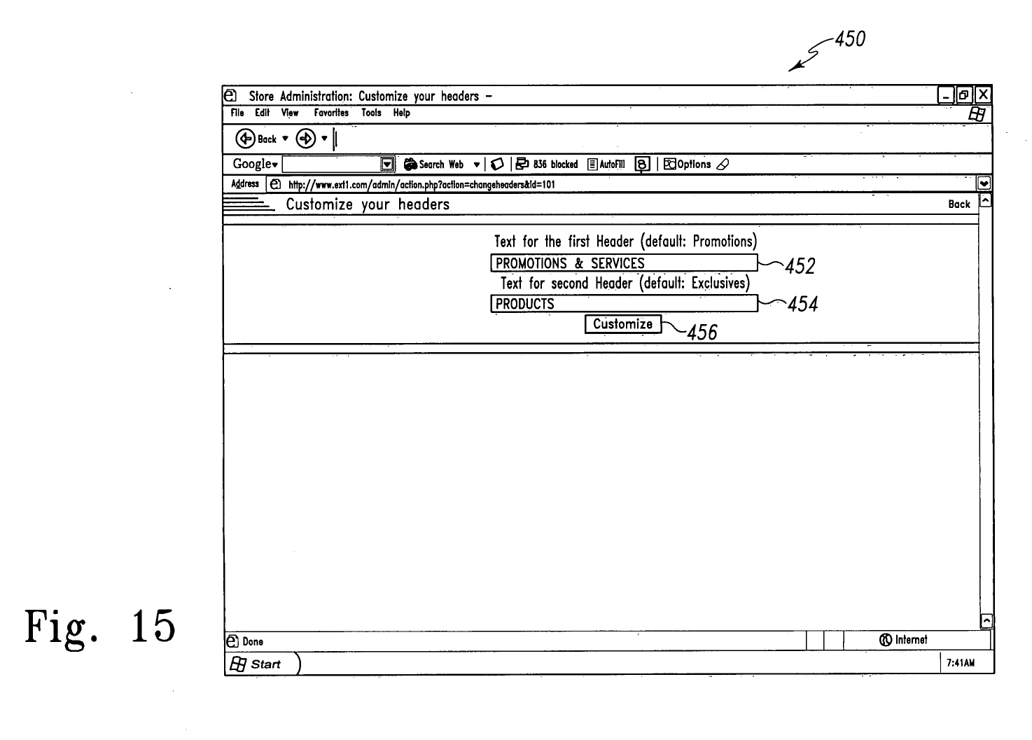

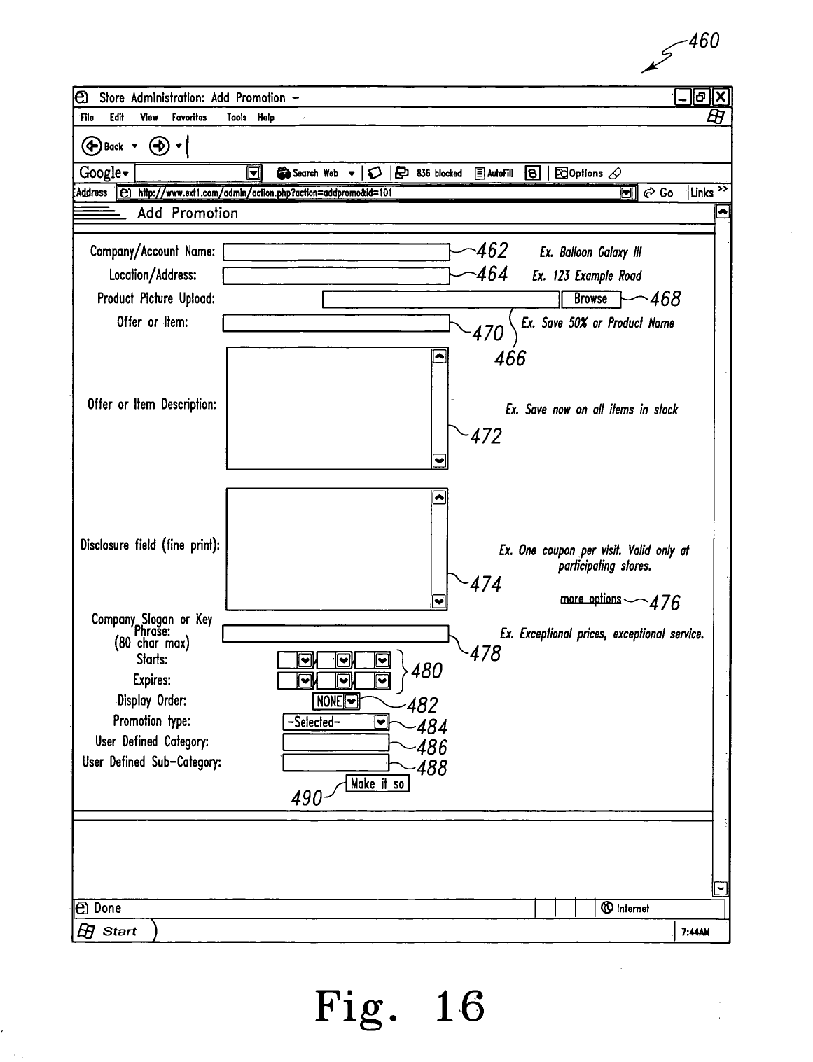

Returning to FIG. 11, additional content for the extension web site can be accessed by selecting one of the available tabs 334 of information. The values displayed in the headers of the content windows can also be modified by selecting the edit headers option 340, and then using the customization screen 440 (FIG. 15) to modify the values for the headers 452 and 454 and selecting the customize option 456. Returning to FIG. 11, the current promotions and services 339 are displayed, if applicable, and the user setting up the site for the company can modify the content. For example, upon selecting add option 346 or 358, an add customization screen is displayed 460 (FIG. 16) where the user can modify various details for the promotion, product, or other item. Various fields or options can be specified, such as company/account name 462, location/address 464, product picture 466, browse option 468 for browsing for a product picture, offer or item 470, offer or item description 472, disclosure field 474, company slogan or phrase 478, start and ending dates for the item 480, order for displaying the item 482, item/promotion type 484, user defined category 486, and user defined sub-category 488. Upon selecting the make it so option 490, the changes are saved to the database. Values for item/promotion type field 484 can be one of various options, such as Product/Item, Sale, Coupon, Service, Menu Item, Event, Class, Educational Material, Program, or Gift Certificate, to name a few non-limiting examples. In one embodiment, the value specified for the item/promotion type field 484 determine which tabs and categories on the screen the content will be displayed in.

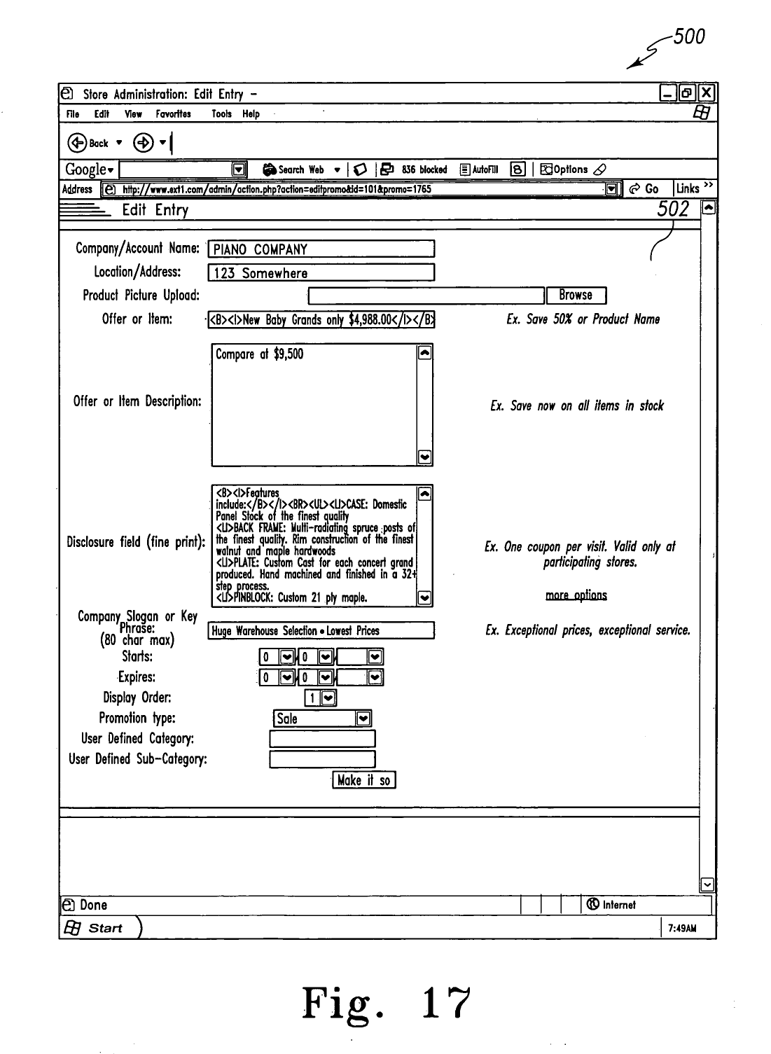

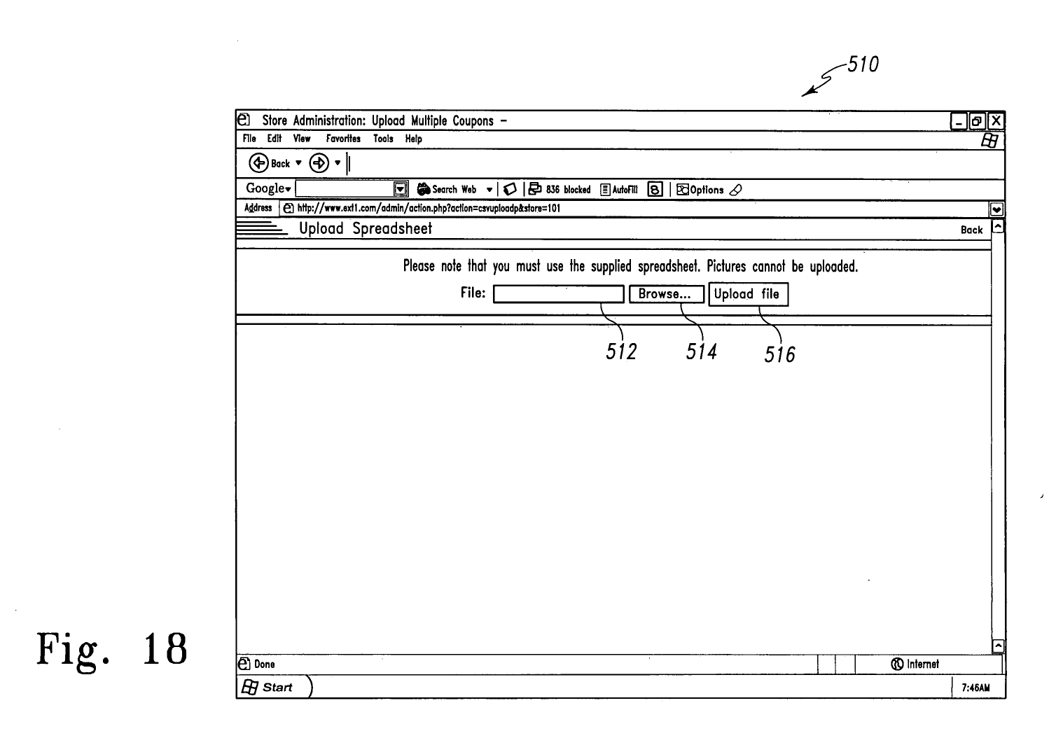

Returning now to FIG. 11, the user can edit the promotions and services or the products currently being displayed by selecting the edit options 352 or 362, respectively. Upon selecting one of the edit options 352 or 362, a customization screen similar to 500 (FIG. 17) is displayed and allows the user to modify the current values for the fields 502. Returning to FIG. 11, upon selection of the delete option 354 or 364, the respective item is deleted from the database. The user can select one of the items 350 to view the detailed information about the item in another window. The user can also select an option to upload a spreadsheet 348 or 360 to allow for data for promotions and services 339 or products 356 to be uploaded from another format. Upon selection of the upload spreadsheet options 348 or 360, a screen 510 similar to FIG. 18 is displayed where the user can specify the name of the spreadsheet file to upload 512, browse for the file 514, and select the upload file option 516 to upload the file when ready. In one embodiment, a particular format is required in order for the program to understand the data values being uploaded.

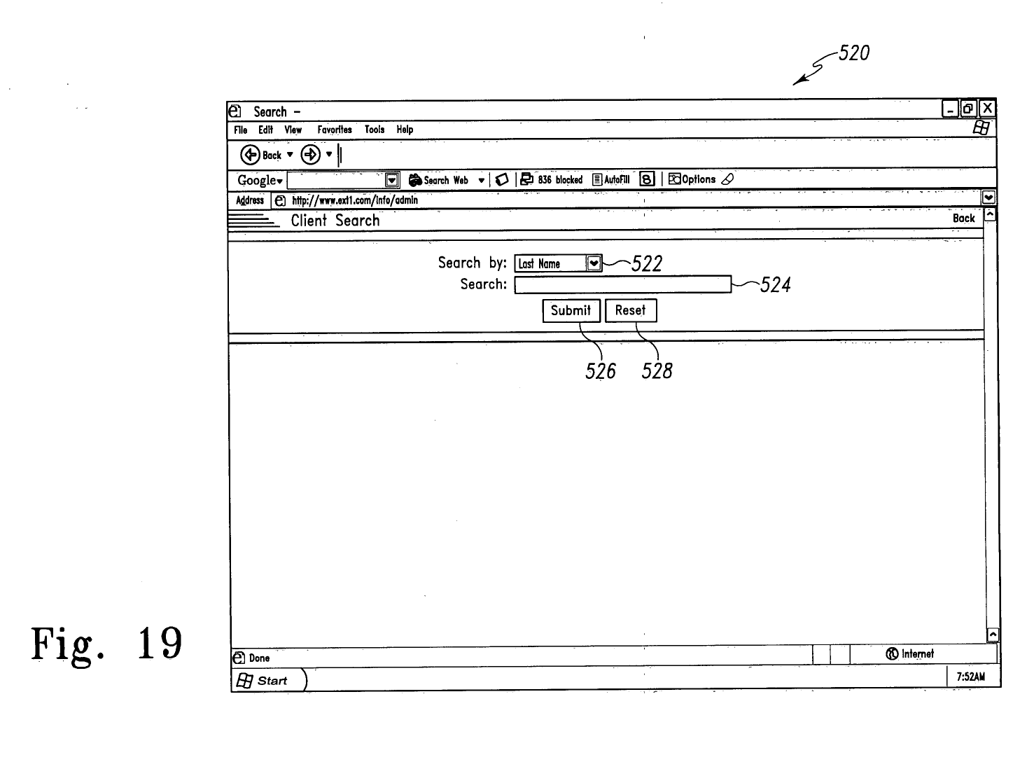

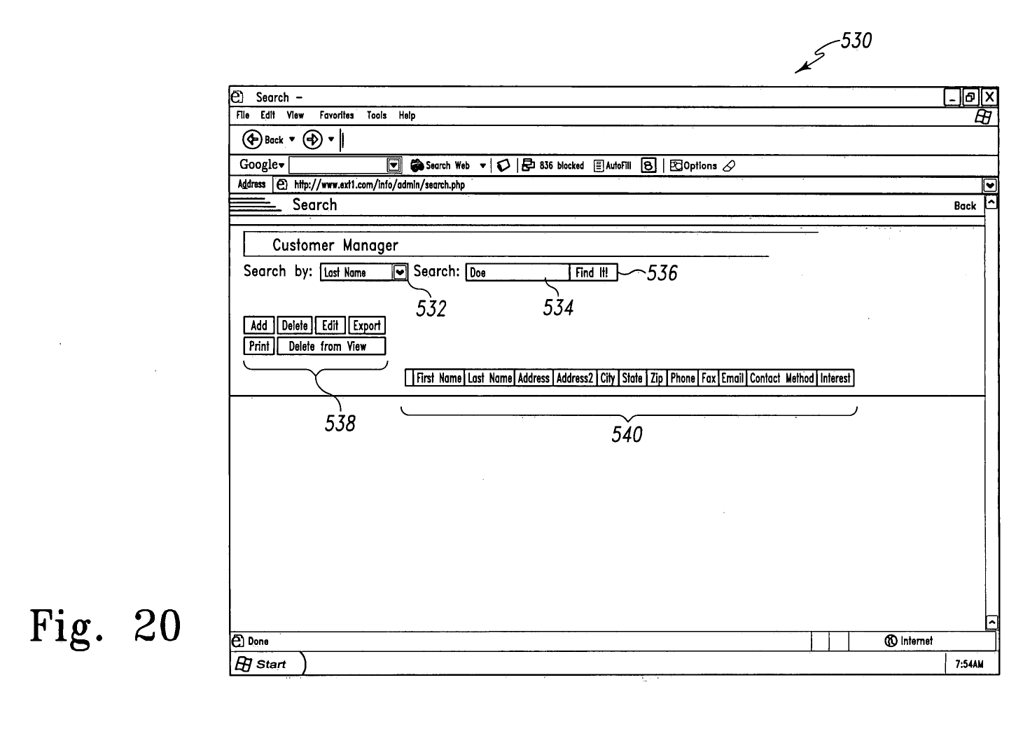

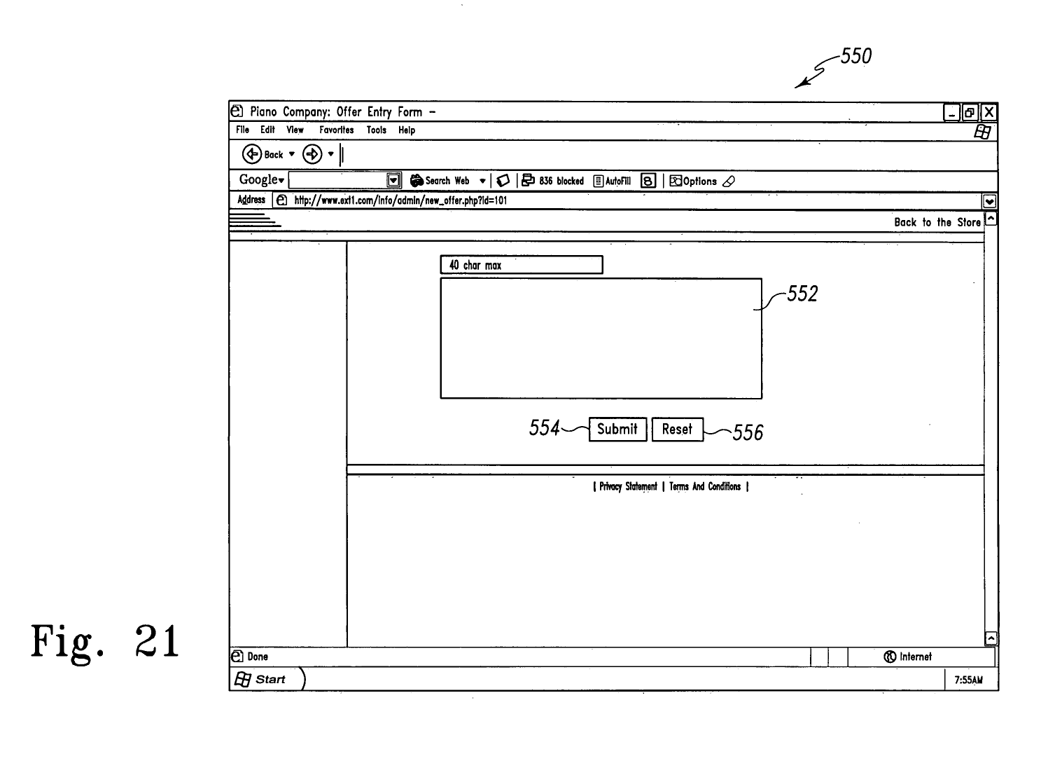

Returning to FIG. 11, upon selecting the keep me posted option 366, the user can submit information to the company to request additional information. In one embodiment, when a user requests information from the company, the user is automatically added to the client contacts database described next. Upon selecting the manage client base option 368, a screen 520 similar to FIG. 19 is displayed to allow the user manage client contacts. For example, upon selecting the field to search by 522, the search criteria 524, and selecting the submit option 526, a search matching the specified criteria is executed. The search can be reset upon selecting the reset option 528. After the search executes from selection of the submit option 526, a screen 530 similar to FIG. 20 is then displayed listing the results of the search 540, along with the search criteria field 532, criteria 534, and find it option 536. Various other options 538 for managing the client contacts are also available, such as add, delete, edit, export, print, and delete from view. Returning now to FIG. 11, upon selecting the input new online item/offer option 370, the user can use customization screen 550 (FIG. 21) to add the new online item/offer details 552 and submit it to the database using the submit option 554. In one embodiment, the online item/offer details option 370 is what allows the company to specify what options or types of information the user can request when they request additional information using keep me posted option 366. The user can also reset the field using the reset option 556.

In one embodiment, the manage client base option 368 offers expanded features. As one example, the company can generate printed or electronic mailings to its customer base automatically from the database. The client contact manager functionality can also include information from third party data providers, such as demographic information that can be used for targeted mailings to persons meeting desired criteria.

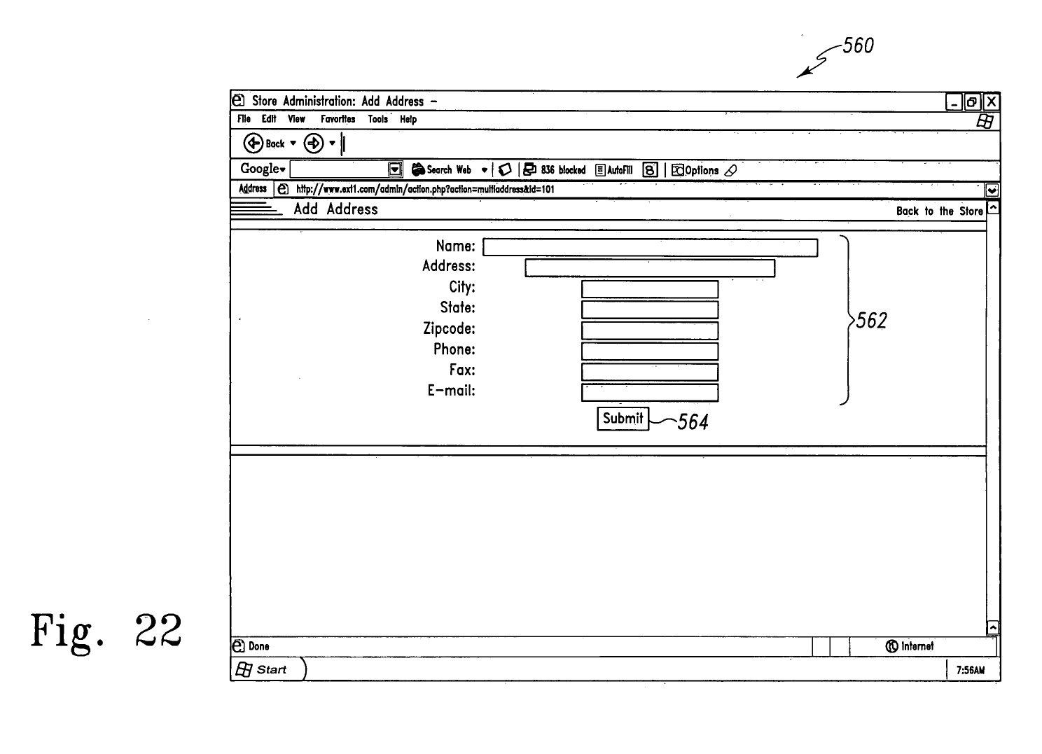

Returning now to FIG. 11, the user can also add a new address by selecting add address option 374, or modify the existing address using modify address option 376. A screen 560 similar to FIG. 22 is displayed to allow the user to add or modify address fields 562 and submit the changes to the database 564. Upon selecting the Go option 372, a list of the existing stores is displayed, if applicable.

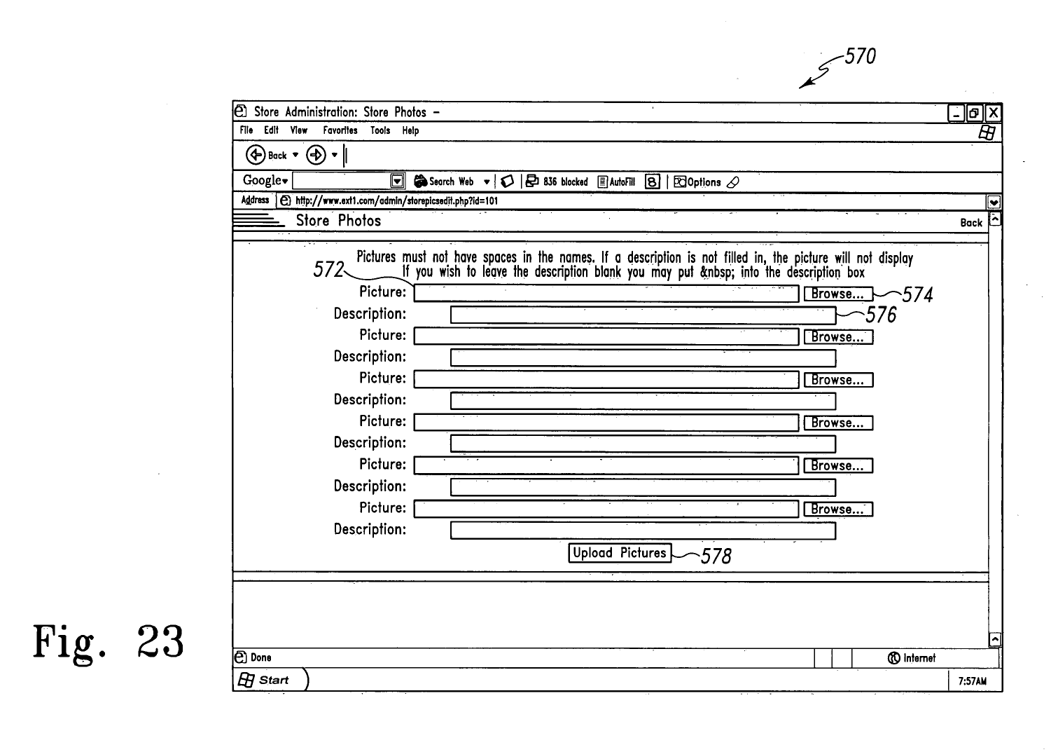

Upon selecting the update option 380, the user can update the store photos that are displayed. A screen similar to FIG. 23 is displayed to allow the user to add additional store photos, such as by specifying a picture path and file name 572, browsing for the file if necessary using option 574, and specifying the description 576 for the picture. Upon selecting the upload pictures option 578, the one or more pictures to be displayed in the store photos section of the web site are then uploaded. Store photos can include photos of the business exterior or interior, or anything else the business feels appropriate.

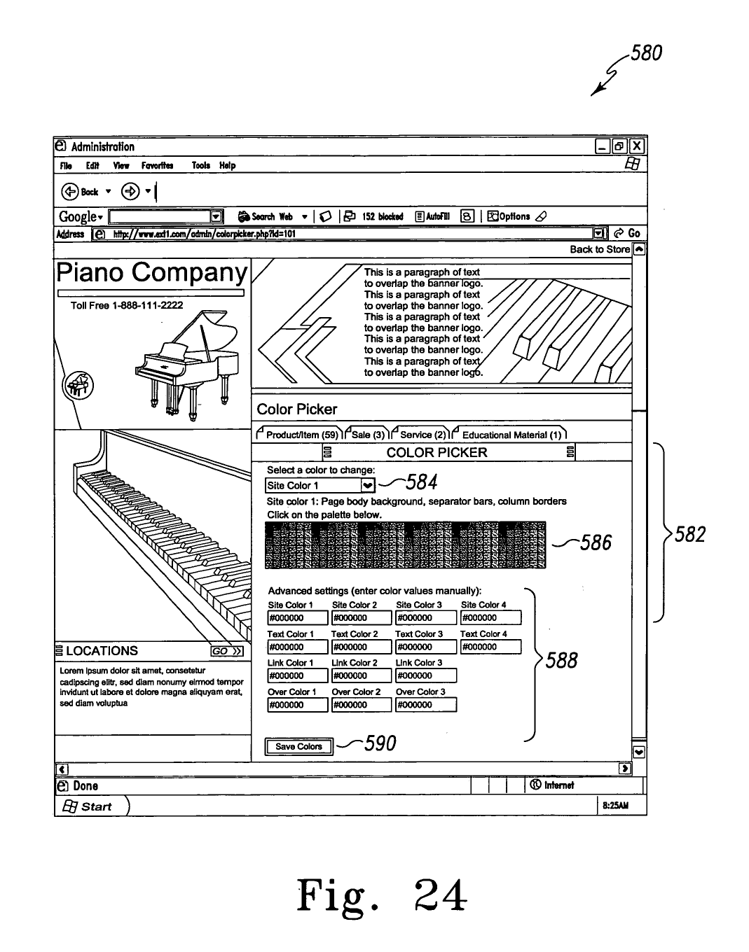

Returning now to FIG. 11, upon selecting the Go option 378, a list of current store photos is displayed, if applicable. Upon selecting Go option 382, a list of information about visitors to the site is displayed, if applicable. The number of visitors 384 who have visited the site is also displayed. Upon selection of the change colors option 386, a screen 580 similar to FIG. 24 is displayed to allow the user to change the color scheme of the extension web site 582. The user can select a color to change 584, and can click on the color palette 586 to specify a new color value. The user can also enter color values manually for the fields 588, and when finished modifying the site's color scheme, can select the save colors option 590.

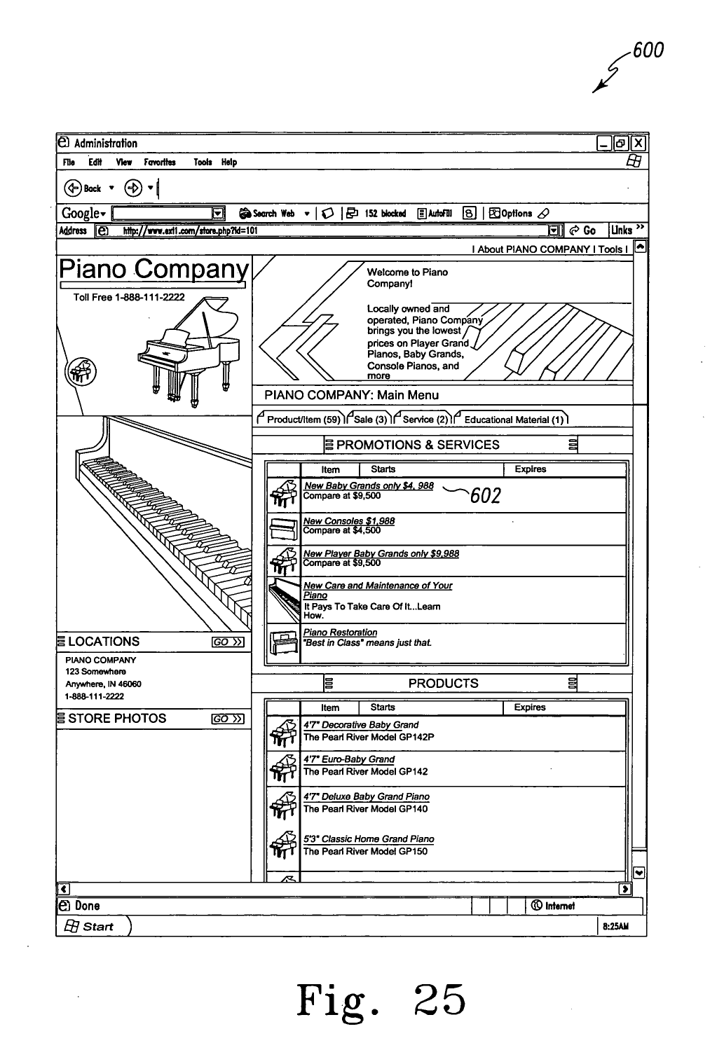

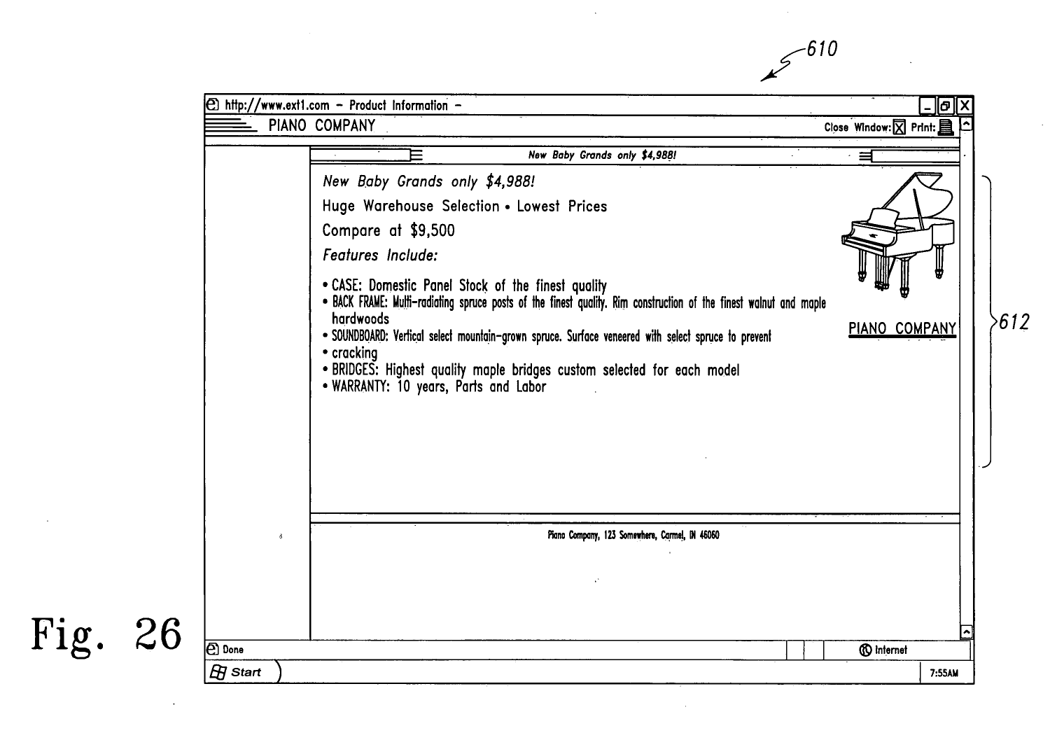

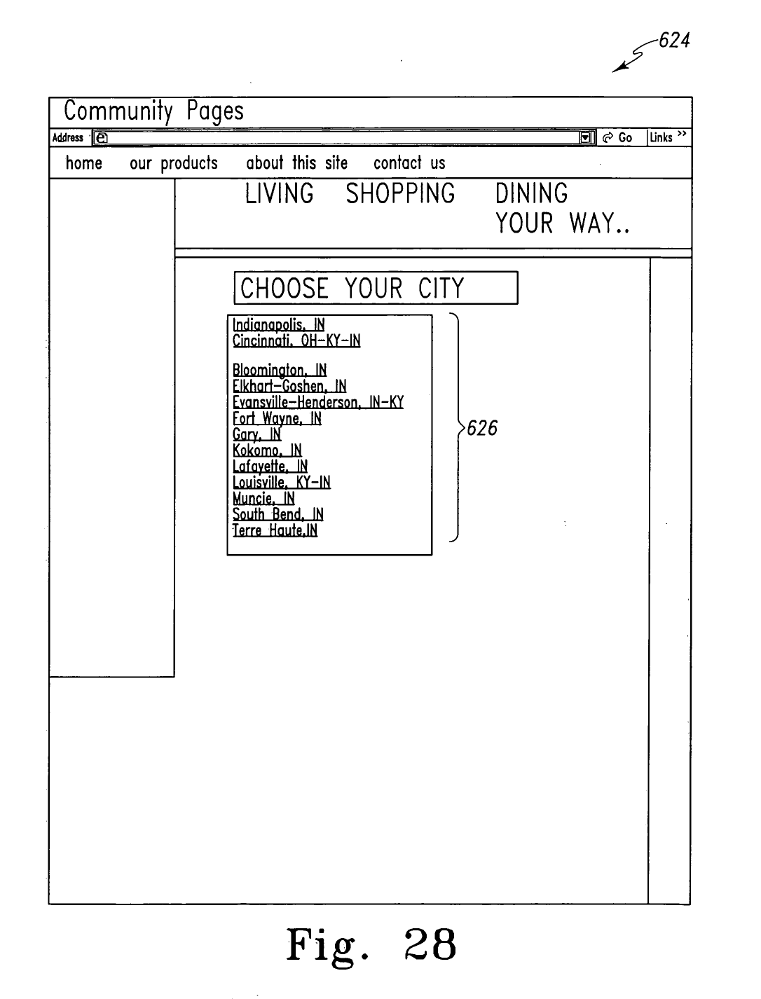

Turning now to FIG. 25, a simulated screen 600 is shown of a browser user interface for one or more client workstations used by a consumer to view a particular extension web site. Note that the site is the same web site shown in the prior examples, only now it is displayed in the format designed for the consumer, versus the format for an administrator or a business owner who is making customizations. This screen can be accessed through the portal illustrated in FIGS. 28-30, or can be accessed by directly typing in the applicable URL. Upon selecting an item 602 from the list, the user can view additional details about the item, such as shown in the secondary window 610 of FIG. 26 with the additional details 612 about the particular piano.

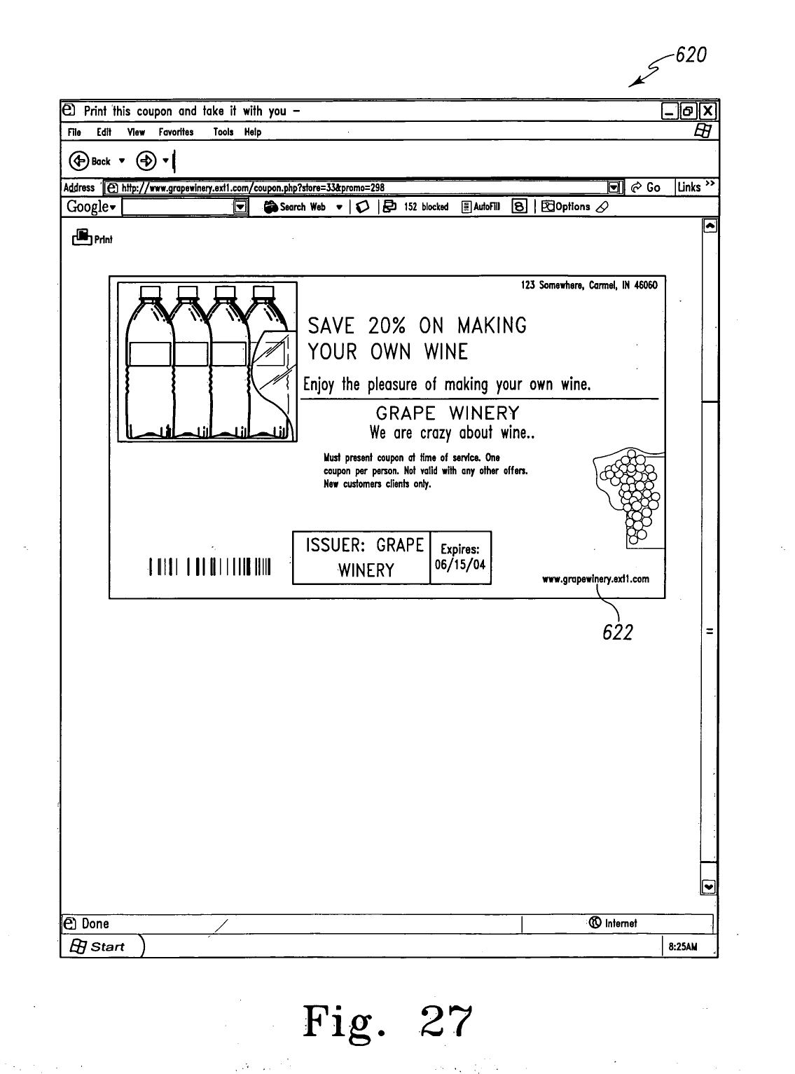

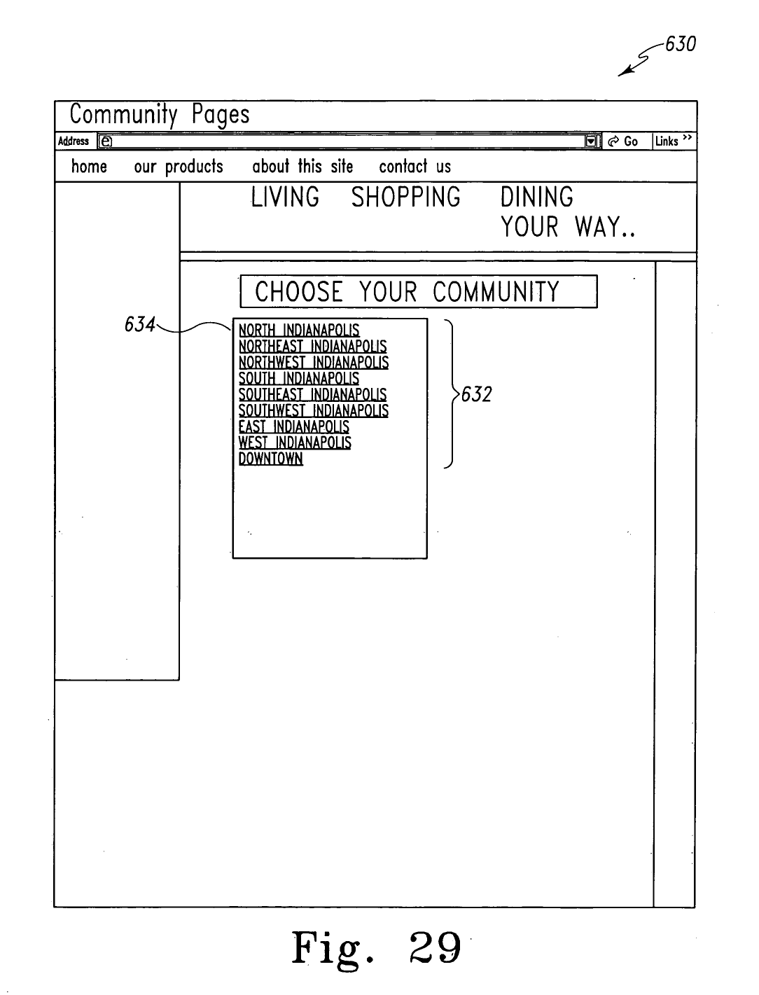

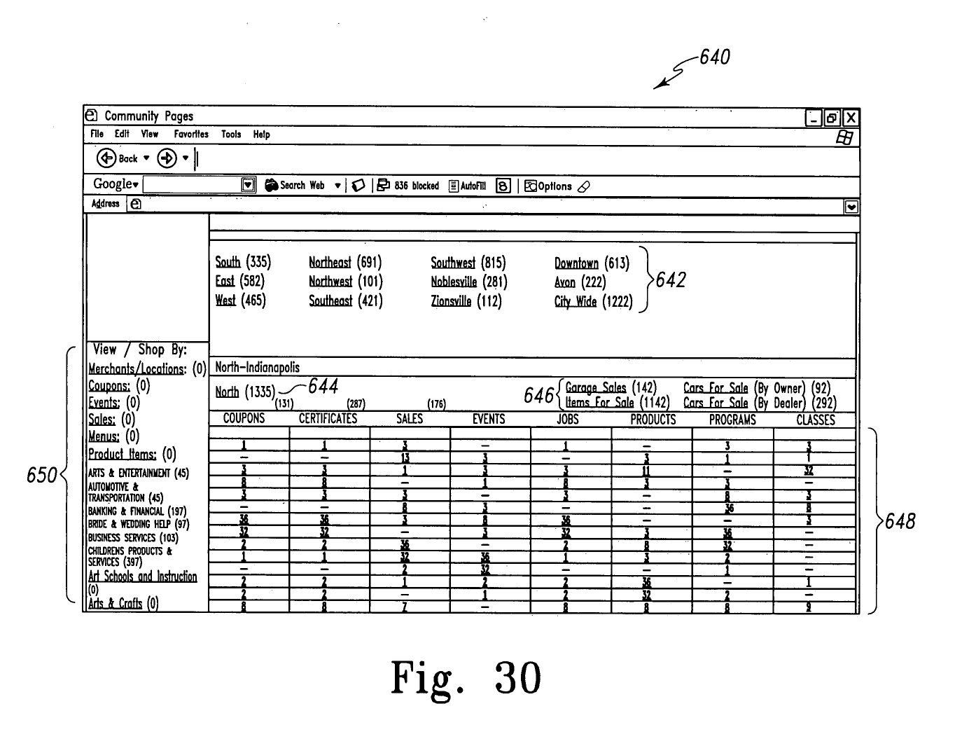

FIG. 27 illustrates viewing a selected coupon for a particular extension web site, which in this example is a different extension web site than the one used in the prior examples. The extension web site address of the particular company 622 is listed on the coupon, so the consumer can visit the extension web site to locate additional coupons that may be of interest. Turning now to FIGS. 28-30, various simulated screens are illustrated of a browser user interface for one or more client workstations used by a consumer to access the community portal to view extension web sites. As shown on the simulated screen 624 in FIG. 28, the user can select a particular city or other region of interest 626. As shown on the simulated screen 630 of FIG. 29, a narrower area of interest can also be specified 632, such as North Indianapolis 634. As shown in FIG. 30, the simulated screen 640 illustrates various categories 650 for the selected geography. Certain summary information is displayed, such as the total number of items available 644 in the given region, the total number of certain other types of information 646, such as garage sales, items for sale, etc. The user can also see information about the number and type of items available 648 from various extension web sites, broken down by the particular item category. The consumer uses the portal to drill-down into the categories. For example, the consumer can select a particular mall near their home to see the specials the various stores may be offering. The consumer can also drill-down to a particular category such as building supplies for their area. Various other categorizations and drill-down methods are also possible that start with region, that start with subject matter category, that start with item category, or that start with other combinations.

In another embodiment, a method is disclosed that comprises: upon receiving a new account creation request, establishing an extension web site for a first user as a sub-domain of an existing domain; providing the first user with near immediate access to a customization tool for the web site at a specified customization URL; receiving input from the first user to use the customization tool to customize a plurality of content on the web site using at least one template, said content to be displayed to a second user in a web browser upon accessing an extension web site URL that includes the sub-domain and the existing domain; and including the extension web site of the first user in a portal web site that includes a plurality of other extension web sites, said portal web site grouping the plurality of other extension web sites and the extension web site of the first user into various categories.

In yet a further embodiment, a method is disclosed that comprises: providing a printed material having a promotion, said printed material including a URL of an extension web site of a first company, said URL including a sub-domain and a domain; displaying the extension web site of the first company to a user when the user accesses the URL from a web browser, said user being someone who received the material; and displaying a plurality of materials available from the extension web site of the first company, said plurality of materials providing the user with more promotions than was present on the printed materials.

In yet another embodiment, a system is disclosed that comprises: at least one server computer; at least one client computer, said client computer coupled to said server computer over a network; and wherein said server computer contains a program that is operable to receive and process a new account creation request to establish an extension web site for a company as a sub-domain of an existing domain, provide a first user having proper login credentials with near immediate access a customization tool for the extension web site at a specified customization URL, receive input from the client computer operated by the first user to allow the first user to use the customization tool to customize a plurality of content on the extension web site using at least one template, said at least one template providing a standardized format so that each of a plurality of extension web sites that are established on the domain will be displayed to a second user in a consistent format, and include the extension web site of the first user in a portal web site that includes the plurality of extension web sites, said portal web site grouping the plurality of extension web sites into various categories.

In another embodiment, an apparatus is disclosed that comprises: a device encoded with logic executable by one or more processors to: receive and process a new account creation request to establish an extension web site for a company as a sub-domain of an existing domain; provide a first user having proper login credentials with near immediate access to a customization tool for the extension web site at a specified customization URL; and receive input from a client computer operated by the first user to allow the first user to use the customization tool to customize a plurality of content on the extension web site using at least one template, said at least one template providing a standardized format so that each of a plurality of extension web sites that are established on the domain will be displayed to a second user in a consistent format; include the extension web site of the company in a portal web site that includes a plurality of other extension web sites, said portal web site grouping the plurality of other extension web sites and the extension web site of the company into various categories.

In yet another embodiment, a method is disclosed that comprises: upon receiving a new account creation request, establishing an extension web site for a first user as a sub-domain of an existing domain; providing the first user with near immediate access to a customization tool for the extension web site at a specified customization URL; receiving input from the first user to use the customization tool to customize a plurality of content on the extension web site using at least one template, said content to be displayed to a second user in a web browser upon accessing an extension web site URL that includes the sub-domain and the existing domain; repeating said establishing the new account step and said receiving input steps for a third user; displaying the content for the extension web site of the first user upon request from the second user; displaying the content for the extension web site of the third user upon request from the second user; wherein the extension web site of the first user is displayed in a format consistent with the content from the extension web site of the third user; and including the extension web site of the first user and the extension web site of the third user in a portal web site that includes a plurality of other extension web sites, said portal web site grouping the plurality of other extension web sites and the extension web site of the first user and the extension web site of the third user into various categories.

A person of ordinary skill in the computer software art will recognize that the client and/or server arrangements, user interface screen content, and data layouts could be organized differently to include fewer or additional options or features than as portrayed in the illustrations and still be within the spirit of the invention.

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the inventions as described herein and/or by the following claims are desired to be protected.

1. A method comprising:
upon receiving a new account creation request, establishing an extension web site for a first user as a sub-domain of an existing domain;
providing the first user with near immediate access to a customization tool for the web site at a specified customization URL;
receiving input from the first user to use the customization tool to customize a plurality of content on the web site using at least one template, said content to be displayed to a second user in a web browser upon accessing an extension web site URL that includes the sub-domain and the existing domain; and
including the extension web site of the first user in a portal web site that includes a plurality of other extension web sites, said portal web site grouping the plurality of other extension web sites and the extension web site of the first user into various categories.

2. The method of claim 1, wherein the first user is a company.

3. The method of claim 2, wherein the second user is an individual who is a potential customer of the company.

4. The method of claim 2, wherein the company also has a primary web site, and uses the extension web site for displaying a set of content that changes more frequently than the primary web site.

5. The method of claim 1, wherein said receiving input step comprises:
receiving at least one logo from the first user; and
receiving at least one textual description of an item in an HTML format.

6. The method of claim 1, further comprising:
repeating said establishing the new account step and said receiving input steps for a third user;
displaying the content for the extension web site of the first user upon request from the second user;
displaying the content for the extension web site of the third user upon request from the second user; and
wherein the extension web site of the first user is displayed in a format consistent with the content from the extension web site of the third user.

7. The method of claim 1, wherein the second user accesses the extension web site URL by typing the extension web site URL in the web browser.

8. The method of claim 1, wherein the second user accesses the extension web site URL by selecting a hyperlink on a different web site that contains the extension web site URL.

9. The method of claim 8, wherein the different web site is the portal web site.

10. A method comprising:
providing a printed material having a promotion, said printed material including a URL of an extension web site of a first company, said URL including a sub-domain and a domain;
displaying the extension web site of the first company to a user when the user accesses the URL from a web browser, said user being someone who received the material; and
displaying a plurality of materials available from the extension web site of the first company, said plurality of materials providing the user with more promotions than was present on the printed materials.

11. The method of claim 10, further comprising:
repeating said providing step and said displaying step for a second company; and
wherein the extension web site of the first company is displayed to the user in a format consistent with the extension web site of the second company.

12. A system, comprising:
at least one server computer;
at least one client computer, said client computer coupled to said server computer over a network; and
wherein said server computer contains a program that is operable to receive and process a new account creation request to establish an extension web site for a company as a sub-domain of an existing domain, provide a first user having proper login credentials with near immediate access a customization tool for the extension web site at a specified customization URL, receive input from the client computer operated by the first user to allow the first user to use the customization tool to customize a plurality of content on the extension web site using at least one template, said at least one template providing a standardized format so that each of a plurality of extension web sites that are established on the domain will be displayed to a second user in a consistent format, and include the extension web site of the company in a portal web site that includes the plurality of extension web sites, said portal web site grouping the plurality of extension web sites into various categories.

13. The system of claim 12, wherein said program is operable to receive at least one logo from the first user and receive at least one textual description of an item in an HTML format.

14. The system of claim 12, wherein said program is operable to allow the first user to upload a plurality of promotions to the extension web site of the company that can be displayed to the second user upon request, said plurality of promotions providing the second user with more incentives than was present on a printed promotion the second user received from the company.

15. An apparatus comprising: a device encoded with logic executable by one or more processors to:
receive and process a new account creation request to establish an extension web site for a company as a sub-domain of an existing domain;
provide a first user having proper login credentials with near immediate access to a customization tool for the extension web site at a specified customization URL; and
receive input from a client computer operated by the first user to allow the first user to use the customization tool to customize a plurality of content on the extension web site using at least one template, said at least one template providing a standardized format so that each of a plurality of extension web sites that are established on the domain will be displayed to a second user in a consistent format;
include the extension web site of the company in a portal web site that includes a plurality of other extension web sites, said portal web site grouping the plurality of other extension web sites and the extension web site of the company into various categories.

16. The apparatus of claim 15, wherein the device is encoded with logic further operable to:
allow the first user to upload a plurality of promotions to the extension web site of the company that can be displayed to the second user upon request, said plurality of promotions providing the second user with more incentives than was present on a printed promotion the second user received from the company.

17. The apparatus of claim 15, wherein the device includes a removable memory device carrying a number of processor executable instructions to define the logic.

18. The apparatus of claim 17, wherein the removable memory device includes a disk.

19. A method comprising:
upon receiving a new account creation request, establishing an extension web site for a first user as a sub-domain of an existing domain;
providing the first user with near immediate access to a customization tool for the extension web site at a specified customization URL;
receiving input from the first user to use the customization tool to customize a plurality of content on the extension web site using at least one template, said content to be displayed to a second user in a web browser upon accessing an extension web site URL that includes the sub-domain and the existing domain;
repeating said establishing the new account step and said receiving input steps for a third user;
displaying the content for the extension web site of the first user upon request from the second user;
displaying the content for the extension web site of the third user upon request from the second user;
wherein the extension web site of the first user is displayed in a format consistent with the content from the extension web site of the third user; and
including the extension web site of the first user and the extension web site of the third user in a portal web site that includes a plurality of other extension web sites, said portal web site grouping the plurality of other extension web sites and the extension web site of the first user and the extension web site of the third user into various categories.

20. The method of claim 19, wherein said receiving input step comprises:
receiving at least one logo from the first user; and
receiving at least one textual description of an item in an HTML format.
